(19) United States
(12) Patent Application Publication
(10) Pub. No.: US 2022/0048244 A1
(43) Pub. Date: Feb. 17, 2022

(54) POLYESTER POWDERS AND THE USE THEREOF IN THREE-DIMENSIONAL PRINTING PROCESSES

(71) Applicant: Covestro (Netherlands) B.V., Nieuwegein (NL)

(72) Inventors: Rudolfus Antonius Theodorus Maria VAN BENTHEM, Echt (NL); Franciscus Johannes Marie DERKS, Echt (NL); Stijn WITTERS, Echt (NL); Adrianus Cornelis Bastiaan BOGAERDS, Echt (NL); Franciscus Adrianus Cornelis BERGMAN, Echt (NL)

(21) Appl. No.: 17/278,929

(22) PCT Filed: Oct. 28, 2019
(86) PCT No.: PCT/NL2019/050707

§ 371 Date: Mar. 23, 2021

(30) Foreign Application Priority Data
Oct. 26, 2018 (EP) 18202920.7

(51) Int. Cl. B29C 64/153; B29C 64/165; B33Y 10/00; B33Y 70/10; C08L 67/03; C08K 3/40; B29B 9/02; C08G 63/183

(52) U.S. Cl. CPC B29C 64/153; B29C 64/165; B33Y 10/00; B33Y 70/10; B29B 2009/125; C08K 3/40; B29B 9/02; C08G 63/183; C08K 2201/005; C08L 67/03

(57) ABSTRACT

The present invention is directed to polyester powders suitable for use in 3D printing processes, methods of using such polyester powders in 3D printing processes, and processes for the manufacturing thereof. The polyester powders prepared in accordance with the present invention are easily recycled after such polyester powders have been subjected to 3D printing conditions. In addition, the present invention is directed to recycling processes that recondition waste polyester powders into polyester powders suitable for 3D printing.

### FIELD OF THE INVENTION

The invention relates to certain polyester powders for 3D printing, their use in 3D printing processes, and processes for the manufacture thereof. Further, the present invention relates to compositions containing the certain polyester powders, to the 3D printed articles produced therefrom, and methods of manufacturing 3D printed articles with the compositions containing the certain polyester powders. Further, the present invention relates to methods of recycling certain polyester powders.

### BACKGROUND

A variety of additive manufacturing processes are known and used. One subset of such processes, which utilizes powder as the build medium, is particularly useful for several end-use applications. Such powder-based additive manufacturing processes include Selective Laser Sintering (SLS), High Speed Sintering (HSS), or MultiJetFusion (MJF). There are known variations between such processes, but powder-based additive manufacturing methods all generally involve the application of a high density, high energy source of radiation, such as a laser, to selectively melt or fuse a portion of particles into a desired shape. A control mechanism serves to direct both the path and intensity of the laser in order to fuse powder disposed within specified boundaries, often on a layerwise basis. Each layer, or “slice,” represents a cross-section of the final component to be fabricated at a specified thickness. Machine controls operate selectively to sinter sequential layers of powder, producing a completed part comprising a plurality of slices sintered together. Preferably, the machine control mechanism is computer-directed, and utilizes CAD files of varying formats to determine the defined boundaries for each slice.

The part may be produced by depositing a first portion of sinterable powder onto a target surface of a part bed, scanning the directed laser over the target surface, and sintering a first layer of the first portion of powder on the target surface to form the first slice. The powder is thus sintered by operating the directed laser beam within the boundaries defining the first slice, with sufficient energy, or fluence, to sinter the powder. The first slice corresponds to a first cross-sectional region of the part.

A second portion of powder may then be deposited onto the surface of the part bed and that of the first sintered slice lying thereon, and the directed laser beam scanned over the powder overlying the first sintered slice. A second layer of the second portion of powder is thus sintered by operating the laser beam within the boundaries which then define the second slice. The second sintered slice is formed at a temperature sufficient to sinter it to the first slice, with the two slices fusing together into a single portion of the object to be built. Successive layers of powder are deposited onto the previously sintered slices, with each layer being sintered in turn to form an additional slice.

A wide variety of materials may be used in powder-based additive fabrication process. Many thermoplastics, metals or ceramics are commonly used. Thermoplastic powders are preferred because they facilitate the creation of three-dimensional components with a wide variety of properties that may be suitable for a large array of end-use applications. Preferred polymeric powders include semi-crystalline thermoplastics because of their improved sinterability when compared to more crystalline thermoplastic materials.

Among thermoplastic polymer types possibly used in powder-based additive manufacturing processes include polyolefins, polyarylketones, polyamides, polyimides, polyesters, polyphenylene sulfides, polyarylketones, liquid crystal polymers, polyacetals, and fluorochemical resins.

Specific examples of the polyolefins include, without limitation, polyethylene and polypropylene.

Specific examples of polyarylketones include, without limitation, polyether etherketone (PEEK), polyetherketone (PEK), polyether ketone ketone (PEKK), polyaryl ether ketone (PAEK), polyether ether ketone ketone (PEEKK), and polyetherketone ether ketone ketone (PEKEKK).

Many polyamides—not all of which are necessarily suitable for use in additive manufacturing processes for various reasons—are known. Two of the most well-known polyamides are poly(hexamethylene adipamide) (PAN or Nylon 6,6) and polycaprolactam (PA6 or Nylon 6). Both PA6 (CAS #25038-54-4) and PA66 (CAS #32131-17-2) have excellent mechanical properties including high tensile strength, toughness, flexibility, resilience, and low creep. They are easy to dye and exhibit excellent resistance to wear due to a low coefficient of friction (self-lubricating). Nylons typically possess a high melting temperature and glass transition temperature, thereby enabling the solid polymers formed therefrom to possess superior mechanical properties even at increased temperatures.

Another well-known polyamide is Nylon 6,12. It is less hydrophilic than Nylons 6,6 and 6 due to the larger number of methylene groups in the polymer backbone. Further polyamides include, without limitation, polyamide 410 (PA410), polyamide 610 (PA610), polyamide 11 (PA11), polyamide 12 (PA12), semi-aromatic polyamide 4T (PA4T), polyamide MXD6 (PAMXD6), polyamide 6T (PA6T), polyamide 9T (PA9T), and polyamide 10T (PA10T). Still further non-limiting examples of commercially available polyamides include PA3, PA7, PA8, PA10, and PA46.

Although the vast majority of currently commercially available powders for additive manufacturing are polyamides, polyesters offer several advantages which could be useful for several end-use applications. For example, Nylons, such as Nylon 6,12, do not readily facilitate the compounding of certain additives, such as flame retardants. Rather, such additives must be added to various Nylons via so-called “dry blends.” Further, polyesters generally exhibit lower moisture uptake than comparable polyamides.

Polyesters may include, without limitation, semi-aromatic copolymers, such as polyethylene terephthalate (PET), polybutylene terephthalate (PBT), polytrimethylene terephthalate (PTT), polyethylene naphthalate (PEN), and other copolymers thereof; aliphatic homopolymers such as polylactic acid (PLA) polycaprolactone (PCL), and aliphatic copolymers such as polybutylene succinate (PBS). Semi-aromatic polyesters often possess improved heat resistance and are commonly used in industrial applications. PBT, which is synthesized via certain reactions of 1,4-butanediol (BD) and TPA, is preferable to many other conventionally used polymers, including polyamides, due to, i.a., its low moisture uptake capacity. It is available commercially from a variety of sources, including DSM under the trade name Arnite®. PBT, along with copolymers thereof, were thought by the present Inventors to be potentially useful in additive manufacturing applications due to a relative high level of thermo-oxidative stability.

PBT is also widely known to crystallize relatively quickly from melt compared to other polyesters, such as PET. Although this characteristic is advantageous in injection molding applications due to the resultant shorter cycle times, lower mold temperatures, and superior dimensional stability, it makes processability in laser sintering applications more difficult. This is because the viable operating window of an additive manufacturing process is directly correlated to the gap between melting and crystallization of the particular material processed. Thus, small deltas between melting and crystallization cause small viable operating windows, making an effective additive manufacturing process difficult or potentially impossible to achieve. In SLS processes, for example, cooler layers of fresh powder are deposited onto a recently-sintered warmer layer. If the gap between the sintered material's melting temperature and crystallization temperature were too narrow, the cooler fresh powder could induce a temperature drop to a point below that material's crystallization temperature. This could result in deformation, curling, or warpage of the portions that were cooled too quickly, and it could further result in a part without appropriate density or part uniformity.

In addition, due to inherent limitations in the three-dimensional printing process, a significant part of the polymer powder is not transformed into the desired shape. This remaining polymer powder (including waste, failed shapes, agglomerated particles, and flushed powder) has typically been exposed to high temperatures (e.g. above 150° C.), oxygen, contaminants, and/or processing fluids for prolonged periods of time, e.g. 1-24 hours. As a result of such exposure, the powder will degrade affecting the melting characteristics, for example. Thus, even after regrinding, materials, especially those with a narrow sinterability region to begin with, cannot be used reliably in the MJF, HSS, or SLS printing processes again.

Existing polyesters for additive manufacturing, including PBT powders for additive manufacturing, do not offer sufficient processability/reusability, because they do not flow appropriately due to particle size variations and/or they are not formed so as to offer a sufficient gap between melting temperature and crystallization temperature.

It would be desirable to provide a powder for additive manufacturing processes that enables the utilization of superior mechanical properties offered by polyesters such as PBTs. Alternatively or additionally, it would be desirable to provide a powder for additive manufacturing that enabled superior flowability and/or the ability for additive compounding. Alternatively or additionally, it would be beneficial to be provide such powders having higher melting points and/or larger “regions of sinterability,” that is the difference between the polymer's melting point onset temperature and its crystallization onset temperature, to improve suitability for use in 3D printing processes. Finally, it further or alternatively would be desirable to provide a polyester powder for additive manufacturing which readily enables superior recyclability and/or reusability.

### BRIEF SUMMARY

The present invention is directed to a process of manufacturing a polymer powder suitable for 3D printing. The present invention is further directed to the polymer powder produced by the process and polymer compositions containing the polymer powder.

The present invention is further directed to processes of 3D printing utilizing the polymer powder and the 3D objects resulting therefrom.

The present invention is further directed to a recycling process that reconditions waste polymer powder into polymer powder suitable for 3D printing.

### BRIEF DESCRIPTION OF THE DRAWINGS

A more complete understanding of the exemplary embodiments of the present invention and the advantages thereof may be acquired by referring to the following description in consideration of the accompanying figures. The same reference numbers are used throughout the figures to depict the same or similar features. In order to facilitate explanation and understanding, the figures provide simplified schematic illustrations, with the understanding that the elements shown are not necessarily drawn to scale.

FIG. 1 depicts a DSC curve for a sample material, further showing thereon to facilitate the determination of various melting and crystallization points of the particular material.

### DETAILED DESCRIPTION

The present invention is directed to providing polyester powders with enhanced suitability for 3D printing. Commonly-described characteristics of polymer powders are crystallization temperature (T_{c}) and melting point temperature (Tₘ). However, inventors posit that a powder's melting point onset temperature (Tₘ, onset) and crystallization onset temperature (T_{c}, onset) are more critical determinants for assessing its potential suitability for use in additive manufacturing processes. This is because the difference between these values, expressed mathematically herein as ΔT=(Tₘ, onset−T_{c}, onset), represents the temperature region within which inventors surmise the powder will be suitable for use in additive manufacturing processes. A powder's ΔT, referred to herein synonymously as its “sinterability region,” must be maximized in order to ensure the powder will behave in a consistent fashion despite the natural temperature variabilities in the additive manufacturing process in which it is used. Powders of the present invention may exhibit larger windows of sinterability than conventional powders of the same type. In order to achieve this, powders of the present invention may also exhibit higher Tₘ, onset values. They may alternatively exhibit lower T_{c}, onset values. Further, they may simultaneously exhibit both higher Tₘ, onset values and lower T_{c}, onset values.

The polymer powder prepared in accordance with the present invention is useful to build 3D objects in a 3D printing process. Further, the polymer powder prepared in accordance with the present invention may be recycled after such polymer powder has been subjected to 3D printing conditions.

The present invention is further directed to a recycling process that reconditions waste polymer powder into polymer powder suitable for 3D printing.

Among polyester powders, a preferred type is polybutylene terephthalate (PBT) or copolymers thereof. Preferably, a copolymer of PBT is any copolymer having at least one PBT block and containing at least 5%, or at least 10% molar equivalents of glycols. Therefore, a first aspect of the present invention is a process for manufacturing a PBT powder for 3D printing comprising providing an oligoester, preferably an oligo-butyleneterephthalate or copolymer thereof (OBT), having a number average molecular mass of less than 9000 g/mol; optionally, micronizing the oligoester or OBT to form an oligoester or OBT powder; optionally, emulsion solidifying the oligoester/OBT or oligoester/OBT powder to form an emulsion-solidified oligoester or OBT powder; and subjecting the oligoester or OBT powder or emulsion-solidified oligoester or OBT powder to solid-state post condensation to form a polyester, preferably a PBT powder or copolymer thereof, wherein either the milling or emulsion solidifying steps, or both, are performed; and wherein the polyester or PBT powder possesses a sinterability region of at least 10° C., or at least 11° C., or at least 12° C., or at least 13° C., or at least 14° C., or at least 15° C., or at least 20° C., or at least 25° C., or between 14-40° C., or between 15-35° C., or between 20-35° C., or between 25-35° C., or between 15-25° C., or between 15-20° C., or between 30-40° C., or between 35-40° C.

### Process for Creating PBT Powder for Additive Manufacturing

As noted, PBTs, along with copolymers thereof, represent a preferred polyester powder according to the first aspect of the present invention. PBT powders for 3D printing processes may be created in a number of ways. Several known syntheses of PBT generally are described in Devroede, J. (2007). Study of the THF formation during the TPA-based synthesis of PBT: Technische Universiteit Eindhoven DOI: 10.6100/IR630627. Common methods for the formation of PBT include a reaction of terephthalic acid (TPA)-based compound with a hydroxyl-containing compound in the presence of a catalyst.

Several terephthalic acid-based compounds may be utilized in the synthesis of OBT/PBT. Preferred are terephthalic acid (TPA) and dimethyl terephthalate (DMT), although cyclic butylene terephthalate oligomers may also be employed.

A key advantage in the production of DMT, as compared with the production of TPA, is that DMT uses no corresponding bromides or acetic acid. This eliminates the requirement for the utilization of expensive, highly corrosion-resistant reaction vessels. Furthermore, DMT is relatively easily purified by distillation. The first commercial synthetic process for DMT involved the (trans)esterification of crude TPA with methanol, which was made by the oxidation of para-xylene using nitric acid. With the development of the Witten process, air oxidation over a cobalt-manganese catalyst system replaced the need of the highly corrosive nitric acid. This process to DMT requires two oxidation and (trans)esterification steps performed in two separate reactors, without the use of a solvent.

TPA, on the other hand, has become a preferential monomer since improved synthesis methods developed by Scientific Design (and commercialized by Amoco) which obviated the costly and corrosive process, along with many of the undesirable byproducts which were required in previous methods relying on the nitric acid oxidation of para-xylene. Current routes for the synthesis of TPA involve a single stage process in which para-xylene is oxidized by air in the presence of catalyst composed of cobalt, manganese and bromide compounds which produces TPA in good yields. Acetic acid is commonly used as a solvent.

Regardless of the TPA-based compound used, embodiments of the first aspect of the invention rely on the combination of said compound with a hydroxyl-functional compound.

Ethylene glycol may be used as an example of a hydroxyl-functional compound in the synthesis of PET. 1,4-butanediol (BD) is a preferred hydroxyl-functional compound in the synthesis of PBT, although small amounts of comonomers may additionally be used. Therefore, in an embodiment, the hydroxyl-functional compound comprises BD. In an alternative embodiment, the hydroxyl-functional compound consists essentially of BD. In an alternative embodiment, the hydroxyl-functional compound consists of BD.

The use of BD as feedstock for polymers is one of its main applications. Besides this, BD is also converted to tetrahydrofuran (THF), which on its turn is predominantly used to synthesize low molecular weight poly(tetramethylene glycol) (also known as polyTHF) for the production of e.g. copolyester-ethers or urethane elastomers. Industrially, most suppliers synthesize BD via the Reppe process. In this route, gaseous acetylene is introduced into an aqueous solution of formaldehyde. The catalyst generally used for this reaction is silica supported copper(II)oxide in combination with 3 to 6% of bismuth oxide. Hereafter, butynediol is hydrogenated by either a nickel or a palladium catalyst. Other routes for the creation of BD are known, however.

A preferred oligoester of step (a) according to the first aspect of the invention, oligo-butyleneterephthalate (OBT), may be created via the combination of the TPA-based compound and hydroxyl-containing compound in the presence of a catalyst in what is known as an (trans)esterification reaction. (Trans)esterification is a known process involving reacting an alcohol with a carboxylic acid. (Trans)esterification utilizes a catalyst and a suitable temperature to produce an oligomer, for example. An oligomer is a molecule of intermediate relative molecular mass, the structure of which comprises a plurality of units derived, actually or conceptually, from molecules of lower relative molecular mass. An oligo-butyleneterephthalate, therefore, as used herein, is an oligomer comprising butyleneterephthalate units.

As used herein, “oligomer” possesses a number average molecular mass (Mₙ) from 600 g/mol to 15 000 g/mol. As used herein, unless otherwise specified, “molecular mass,” Mₙ, or “number average molecular mass” means number average molecular mass, as measured by proton nuclear magnetic resonance spectroscopy (H-NMR). H-NMR seeks to apply NMR spectroscopy with respect to hydrogen-1 nuclei within the molecules of a substance, in order to determine the structure of its molecules. For an analysis of a substance's entire molecular weight distribution, gas permeation chromatography (GPC) methods may also be employed. As used to analyze the molecular weight distribution of substances described herein, GPC is utilized with polymethylmethacrylate standards in a solution of hexafluoroisopropanol (HFIP) with 0.1 wt. % of potassium trifluoroacetate at 35° C.

The (trans)esterification to forming OBT according to the present invention varies depending on the starting TPA-based compound used. When the OBT is produced via the reaction of DMT in the presence of an excess of BD (DMT-route), it follows the following scheme:

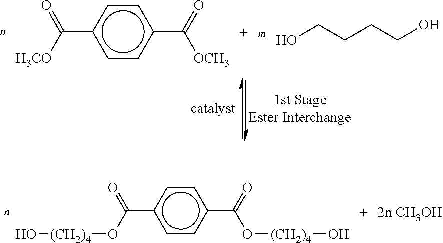

In the so-called DMT route, these monomers may be reacted in a two-stage melt polymerization process in which primarily (in the first stage, also referred to as the esterinterchange stage) the molten DMT and a mixture of BD with the catalyst are charged into a first reactor. During this (trans)esterification reaction, which is generally performed in an inert atmosphere to prevent oxidative side reactions, the temperature is increased and maintained to a temperature of between about 140° C. to about 230° C. With respect to the catalyst used for the (trans)esterification of OBT, one and the same metal complex is used for both stages of the process. Generally, tetra-alkoxy titanates are applied, often in combination with a certain cocatalyst. In an embodiment, the catalyst comprises titanium or magnesium acetate. The excess of BD in the initial reaction mixture is commonly lower than 100%. At the end of the (trans)esterification stage, not exclusively bishydroxybutyl terephthalate is formed; indeed, OBT oligomers bearing hydroxyl end groups appear as well. When no more methanol is distilled off, the reaction mixture is transferred to a second reactor (for the second stage or polycondensation stage) where vacuum is applied (approximately 1 mbar) at increased temperatures (such as between 250° C. and 260° C.), well above the melting temperature of PBT, in order to strip off the excess BD released by a forward polycondensation reaction between two hydroxybutyl end groups. In this way, the 1:1 stoichiometry is gradually restored eventually affording sufficiently high molecular weight OBT. Further details on the DMT-route are described in Study of the THF formation during the TPA-based synthesis of PBT, cited above.

Alternatively, when the OBT is produced via the reaction of TPA in the presence of an excess of BD (TPA-route), it follows the following scheme:

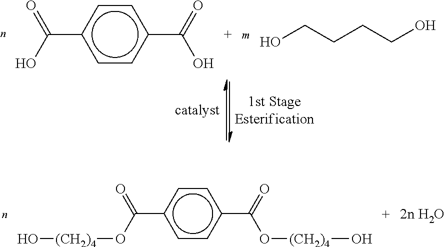

The (trans)esterification process to create OBT based on TPA is very similar to the DMT-based route described above. In this approach, TPA is esterified with an excess of BD, distilling of H₂O in order to shift the (trans)esterification equilibrium towards the product, i.e. hydroxybutyl end functionalized OBT. However, whereas DMT is added as a liquid to the first reactor of the process and is completely miscible with the reaction mixture, TPA is a solid that is only sparsely soluble in BD at the temperatures applied for the melt polymerization. Hence, to feed the first (trans)esterification reactor, a slurry of TPA in BD is prepared. The reaction mixture becomes homogeneous when practically all carboxylic groups have been esterified with BD. At that moment, the so-called ‘clearing point’ is reached and the second stage, which is basically identical to the DMT-based process, is commenced. The catalytic system applied in the TPA-based polymerization of PBT, consists in most described processes of a titanium-based catalyst with or without the addition of a co-catalyst (e.g. potassium terephthalate, sodium acetate, sodium phosphate or other organic/inorganic salts).

Regardless of the process used, according to preferred embodiment of the first aspect, the OBT is the result of a polymerization which is modified relative to currently commercially-available PBT known to Inventors. That is, it is controlled so as to possess a number average molecular mass of less than 9000 g/mol. It is believed that maintaining the molecular weight of the OBT in this step to such values improves the flowability of the ultimate PBT powder (or PBT copolymer) derived therefrom, in part because the prevalence of longer-chain thread-like particles created by the downstream micronizing step are thereby reduced. Furthermore, OBT with such values is thought to facilitate downstream micronizing and optional emulsification steps to further improve the sphericity of the powder particles derived therefrom. These powder characteristics are all helpful in additive manufacturing applications.

In a preferred embodiment, the OBT has a number average molecular mass of 1000 g/mol to 9000 g/mol, or from 1000 g/mol to 8000 g/mol, or from 1000 g/mol to 5000 g/mol, or from 2000 g/mol to 4000 g/mol. OBT with a molecular mass value greater than the aforementioned amounts tends to be insufficiently brittle. This induces deformation during the milling step, and results in a powder with undesirable variances that will inhibit appropriate powder flow during processing in additive manufacturing applications. Conversely, if the molecular mass falls too low, the OBT formed thereby becomes too brittle and shatters during the milling step. This, too, will result in fragments and variations that are inimical to optimal final powder processability.

In embodiments, the molecular weight distribution of the OBT is maintained as narrowly as practical, as doing so will ensure a more uniform PBT powder after the downstream processes in the powder production according to the methods of the invention described herein.

Suitable catalysts for (trans)esterification include, but are not limited to, metallic oxides including zirconium (Zr), molybdenum (Mo), titanium (Ti), tungsten (W), antimony (Sb), tin (Sn), hafnium (Hf), and germanium (Ge), along with the salts and mixtures thereof. For example, suitable catalysts may be ZrO₂, WO₃, TiO₂, and MoO₃. Yet another class of potential catalysts include acid catalysts and salts. Many acids can function as proton sources, and strong acids are particularly useful in catalyzing the hydrolysis and (trans)esterification of polyesters. Specific examples of acid catalysis include hydrofluoric acid (in the alkylation process), phosphoric acid, toluenesulfonic acid, polystyrene sulfonate, heteropoly acids, and zeolites. Specific further examples include Sn(EtHex)₂, Ti(OBu)₄, Ti(N(SiCH₃)₂)₃, Sn(tOBu)₄, Zr(OBu)₄, Hf(OBu)₄, Zn(OAc)₂, Sb₂O₃, Bi(OAc)₃, Al(sec-OBu)₃, Nd(iOPr)₃, Er(iOPr)₃, Yₓ(OBu)_{y}, 2 THF, Ce(iOPr)₄.iPrOH, and GeO₂.

In addition to pure OBTs/PBTs, copolymers thereof are known. Such copolymers preferably comprise a hard segment and a soft segment.

The hard segment preferably has as repeating unit chosen from the group consisting of ethylene terephthalate (PET), propylene terephthalate (PPT), butylene terephthalate (PBT), polyethylene bibenzoate, polyethelyene naphatalate, polybutylene bibenzoate, polybutylene naphatalate, polypropylene bibenzoate and polypropylene naphatalate and combinations thereof. Preferably, the hard segment is butylene terephthalate (PBT), as it facilitates the creation of a resulting thermoplastic copolyester having good processing properties and excellent thermal and chemical resistance.

The soft segment, meanwhile, may include an aliphatic polyether, aliphatic polyester, aliphatic polycarbonate, dimer fatty acids, dimer fatty diols, and/or combinations thereof.

Soft segments chosen from aliphatic polyesters have repeating units derived from an aliphatic diol, and an aliphatic dicarboxylic acid or repeating units derived from a lactone. Suitable aliphatic diols contain generally 2-20 C-atoms, preferably 3-15 C-atoms in the chain and an aliphatic dicarboxylic acid containing 2-20 C atoms, preferably 4-15 C atoms. Examples thereof include ethylene glycol, propylene glycol, butylene glycol, 1,2-hexane diol, 1,6-hexamethylene diol, 1,4-butanediol, cyclohexane cyclohexane dimethanol, and mixtures thereof. Preferably, 1,4-butanediol is used. Suitable aliphatic dicarboxylic acids include sebacic acid, 1,3-cyclohexane dicarboxylic acid, 1,4-cyclohexane dicarboxylic acid, adipic acid, glutaric acid, 2-ethylsuberic acid, cydopentanedicarboxylic acid, decahydro-1,5-naphtylene dicarboxylic acid, 4,4′-bicyclohexyl dicarboxylic acid, decahydro-2,6-naphthylene dicarboxylic acid, 4,4′-methylenebis (cyclohexyl)carboxylic acid and 2,5-furan dicarboxylic acid. Preferred acids are sebacic acid, adipic acid, 1,3-cyclohexane dicarboxylic acid, 1,4-cyclohexane dicarboxylic acid. Most preferred is adipic acid.

In an embodiment, the soft segment is polybutylene adipate (PBA) which may be obtained from 1,4-butanediol and adipic acid. The soft segment may comprise aliphatic polyethers, which may further comprise units of polyalkylene oxides, such as polyethylene oxide and polypropylene oxide and polytetramethylene oxide and combinations thereof, either as individual segment or combined in one segment. A combination includes, by way of example, an ethylene oxide-capped polypropylene oxide.

In an embodiment, the soft segment comprises polytetramethylene oxide (PTMO). In another embodiment, the soft segment(s) include a block copolymer in which two types of glycols are reacted to form a soft segment such as based on poly(ethylene oxide) (PEO) and polypropylene oxide (PPO). The latter is also referred to as PEO-PPO-PEO, as the PEO blocks are at the ends of a soft segment as PEO reacts best with a hard segment. PTMO, PPO and PEO based soft segments allow for foams having a lower density.

In yet other various potential embodiments, the soft segment may be an aliphatic polycarbonate which is preferably made up of repeating units from at least one alkylene carbonate.

In still further potential other embodiments, the soft segment may comprise dimer fatty acids, dimer fatty diols, or combinations thereof. The dimerized fatty acids may contain any number of carbon atoms, but those containing from 32 to 44 are more preferred. Suitable dimer fatty diols which may be derived from the dimer fatty acids as disclosed above, such as, for example, a dimerized fatty diol that may be obtained as a derivative of the dimerized fatty acid by hydrogenation of the carboxylic acid groups of the dimerized fatty acid, or of an ester group made thereof. Further derivatives may be obtained by converting the carboxylic acid groups, or the ester groups made thereof, into an amide group, a nitril group, an amine group or an isocyanate group.

Whether a homopolymer or copolymer is used, in an embodiment, step (a) is carried out and maintained at a temperature of between 25 to 260° C., more preferably from 140 to 230° C.

After the combining step (a), the powder creation process according to the first aspect of the invention involves the optional step of micronizing the OBT to form an OBT powder with, i.a., a desired average particle size or particle size distributions. Micronizing may occur by any methods which are known in the art to which this invention applies.

A preferred method of micronizing is milling the OBT to form an OBT powder. The OBT is subjected to milling to provide a particle size suitable for the intended printing process. The milling can be done at or around room temperature (e.g. 10 to 30° C.) but may be lower for other methods such as cryogenic milling. With cryogenic milling, or cryo-milling, the polymer is cooled down with liquid nitrogen (alternatives to N₂ include solid or liquid carbon dioxide) to prevent softening and clogging of the apparatus during milling. Physical filtering or sieving may then be performed to maintain particles below a desired maximum size.

Other well-known milling techniques include jet milling and mechanical milling. Jet milling processes, for example, grind materials by using a high-speed jet of compressed air or inert gas to impact particles into each other. Jet mills can be designed or used to output particles below a certain size, while continuously milling particles above that size, resulting in a narrow size distribution of the resulting product. Particles leaving the mill can be separated from the gas stream by cyclonic separation.

Milling techniques, especially mechanical milling, may be carried out in a pinned-disk mill, a fluidized-bed opposed jet mill, or a baffle-plate impact mill. Regardless of the milling technique and equipment used (all of which is well-known in the art to which this invention applies), the process should be carried out such that the resulting particle size distribution has a median particle size D50 is in the range from 1 to 650 μm, or more preferably from 1 to 400 μm, or for example, 10 to 200 μm, 20 to 100 μm, or 40 to 50 μm. Median particle size D50 may be determined via various methods, including TEM, SEM, dynamic light scattering, and static light scattering. A non-limiting example of a suitable device for measuring the particle size includes the LB-550 machine, which is available from Horiba Instruments, Inc., and which measures the particle diameter by dynamic light scattering. A preferred method for determining D50 median particle size is via laser diffraction particle size analysis in accordance with ISO 13320-1.

In a preferred embodiment, the OBT is milled to a particle size distribution with a D50 particle size in the range of 30 to 80 μm, or from 40 to 50 μm. A narrow particle size distribution having a mean particle at the sizes listed is desirable because it tends to improve the flowability of the ultimate powder created therefrom. This ensures superior processing and a reduction in agglomeration when such powder is used in powder-based additive manufacturing processes, such as multi-jet fusion or selective laser sintering.

In a preferred embodiment, the micronizing step comprises a jet milling or mechanical grinding process, wherein the jet milling or mechanical grinding process is carried out at a temperature of 15 to 35° C., or from 15 to 30° C.

After micronizing, the particles can be submitted to a post-treatment in a mixer with severe shear, preferably below the melting point onset temperature or glass transition temperature of the polymer in order to round the particles. Other further treatments of the particles in order to obtain the rounding of the particles for improved flow can be a fractionation step via sieving, sifting, or adding powder-flow aids. The rounding of the particles is advantageous because it facilitates the creation of particles with increased sphericity. This, in turn has a positive effect on the flow potential of the powder for maximized suitability in 3D printing applications.

In an alternative embodiment, the OBT is also subjected to an optional emulsion solidifying step. This step may be carried out after the micronizing step, or alternatively, it may be conducted in lieu thereof. Although both the micronizing and emulsion solidifying steps are optional individually, according to preferred aspects of the first embodiment of the invention, at least one of the two (or both) of the steps are employed. An emulsion is a mixture of two or more immiscible liquids. In a two-phase emulsion, one liquid is dispersed as droplets into the other in a so-called continuous phase. The inherent low melt viscosity of the OBT of the current invention makes it particularly processable in two-phase emulsions.

The emulsion solidifying step offers several advantages. First, it yields fewer waste products, such as “fines” and “coarses” than milling processes, which in turn affords a superior, more narrow particle size distribution. Also, the extraction of highly spherical particles created by the natural surface tension forces imparted by the emulsion leads to rounder, more flowable particles. Because emulsions facilitate the collection of a series of highly spherical particles with a desired size distribution, this step tends to obviate or reduce the reliance on certain additives such as flow improvers/modifiers to improve processability. The reduced reliance on additives in turn has the tendency to improve the mechanical properties of the objects produced therefrom, as a greater percentage of property-building PBT (or copolymer thereof) powder may be used in the build composition.

If used, the emulsion solidifying step involves, therefore, the introduction of the OBT/OBT powder into a solvent. The solvent is preferably one with a high boiling point to ensure it remains liquid throughout the entire process. Preferred solvents for this purpose include many ionic liquids or silicone oils, such as polydimethylsiloxane (such as IM-22 from Wacker Chemie AG; Mₙ of approximately 2 kgmol⁻¹). With the OBT and solvent mixed, the emulsion is preferably heated, such as to about 250° C., and then vigorously stirred. Stirring may occur by any means, including, by way of example, a batch polymerization reactor/batch glass autoclave for a specified period of time. After the stirring is complete, or even while the stirring continues, the emulsion may then be cooled to a point—such as room temperature, for example—so as to facilitate the solidification of the OBT and a ready phase separation with the still-liquid solvent. The liquid solvent may then be removed by known methods such as decantation. The remaining solid OBT particles may then be washed with appropriate washing agents, such as acetone. After this, the cleaned, emulsion-solidified solids may then be dried according to conventional methods, including vacuum-drying.

In order to facilitate the creation of a PBT (or copolymer thereof) powder with sufficiently large molecular weight values and acceptable mechanical properties, and further ill order to facilitate the creation of desired sinterability regions to ensure processability amenable for processing in additive fabrication applications, the OST powder is then subjected to a solid-state post condensation step. Solid-state post-condensation processes for increasing the molecular weight of certain polymers are known. Such a method for increasing the molecular weight of polyamides is described in, for example, U.S. Pat. No. 7,767,782 B2, assigned to DSM IP Assets B.V.

Solid-state post-condensation (SSPC) is a process by which the molecular weight of a polymer (or oligomer, such as an oligo-butyleneterephthalate) is gradually increased to a desired value by exposing the material in the solid-state at elevated temperature to an inert gas atmosphere. SSPC is often applied to polyamide prepolymers and is used in industry to prepare high molecular weight polyamides. Inventors have applied a similar concept to increase the molecular weight of oligoester powder to form high molecular weight polyester powder as well. SSPC is practically always carried out at elevated temperature, in a vacuum and in an inert atmosphere. For example, the SSPC may occur in a tumble reactor under a vacuum in an inert gas atmosphere and with input of heat. Nitrogen may be added as a “sweep gas,” which tends to increase the reaction speed. It may alternatively occur at atmospheric pressure with a nitrogen flow removing condensate. In a preferred embodiment, the SSPC processes is performed under inert gas.

In an embodiment, in order to maximize the effect, the SSPC process is performed by heating the polyester material to elevated temperatures, such as greater than 135° C., or greater than 150° C., or greater than 165° C., greater than 175° C., or greater than 190° C., or greater than 200° C. The time which the material should be heated to achieve maximum desired effect depends upon the characteristics of the material used, the temperature and pressure under which the SSPC process is performed, and the nature and flow rate of the inert gas used. However, in an embodiment where PBT is being formed via SSPC, the heating step may preferably be conducted such that the material is heated to at least 165° C. for a minimum of 3 hours, preferably more than 5 hours, or from 5 to 100 hours, or from 5 to 80 hours, or from 10 to 70 hours, or from 10 to 50 hours, or from 5 to 50 hours, or from 20 to 60 hours. In a particularly optimized processes wherein the reaction is configured to occur faster, a heating time of less than 3 hours can be also envisioned.

Advantageously, the material is increasingly heated during the SSPC process such that it achieves a higher temperature at a subsequent point in the process than the temperature to which it was heated during the start of the process. This may be done continuously or in discrete intervals as preferred. In either event, however, the material should not be heated to temperatures approaching—and especially not exceeding—its melting point, or agglomeration of the powder will begin to occur. Preferably, the material should not be heated to above 5-10° C. below its melting point. Alternatively, the material will not be heated to a temperature exceeding its Tₘ, onset value. This value will depend on the specific polyester powder used, as will be known to those of skill in the art to which this invention applies. In an embodiment, an OBT starting material may be heated for approximately 7 hours at 185° C., followed by 15 additional hours at 210° C., all while being subjected to a vacuum at a pressure of roughly 0.8 millibar, and while being subjected to an inert environment consisting of a flow of 2 grams of Nitrogen gas per hour per 1000-liter reactor.

Pressure and temperature are other process variables. High temperature and low water vapor content contribute to increasing the reaction rate of the solid-state post-condensation. Caution is advised when adding too much water vapor during the SSPC of PBT, however, because polyesters are highly sensitive to unwanted hydrolysis side reactions. On the other hand, it may be beneficial to add some moisture, such as superheated steam, to the nitrogen (if used) in order to mitigate the build-up of static electricity, which might otherwise cause agglomeration and/or fouling of the walls and a heat transfer reduction.

With solid-state is meant the state wherein the oligomer or polymer has a temperature below its melting temperature. The melting temperature of the material is here understood to be the peak temperature of the melting peak measured by Differential Scanning calorimetry (DSC) in an open cup with a heating rate of 10° C./min. For materials that decompose, rather than melt, when heated, the melting temperature is understood in this application to be the temperature, measured by DSC or thermogravimetrical analysis (TGA) in an open cup with a heating rate of 10° C./min, at which the material exhibits the highest decomposition rate (i.e. peak).

An inert gas atmosphere is understood in this application to be a gas atmosphere essentially free of oxygen. Such an inert gas atmosphere can comprise, for instance, nitrogen, argon, carbon dioxide, steam or mixtures thereof, together with gaseous products from the reacting polymer mass. Typical pressures used for the gas atmosphere vary from 0.001 mbar to 10 bar, or from 0.1 mbar to 10 mbar, depending on process and type of equipment.

The dew temperature of a gas atmosphere is understood to be the temperature at which, upon cooling of the gas atmosphere, the water vapor in the gas atmosphere starts to condense. Suitable methods for controlling the dew temperature of a gas atmosphere are, for example: mixing of a dry gas with 100% water vapor in the ratio that corresponds with the required dew temperature; cooling of a gas atmosphere containing excess water vapor to the temperature that equals the required dew temperature, such as by passing a through a scrubber in order to condense and remove the excess water; and drying of the feed gas by passing the gas through an absorbent such as molecular sieves or through a desiccant, such as phosphorus pentoxide or the like.

As stated, during post-condensation, generally the molecular weight of the material increases. Increase in molecular weight can for instance be followed by measuring the viscosity of a solution of the oligomer or polymer in a solvent suitable for dissolving the material. The viscosity of polyesters and polyamides, for example, may be measured in formic acid or in 96% sulfuric acid. Preferably, the viscosity of OBT/PBT/copolymers thereof is measured in m-cresol. The viscosity level can be expressed, for example, as a viscosity number (VN). Measurement of the viscosity in terms of a viscosity number is carried out according to ISO 307, with a polyester or polyamide concentration of 0.005 g/ml in 90 wt. % formic acid. In case the material does not dissolve in formic acid, the viscosity number is measured in 96 wt. % sulfuric acid. (International Organization for Standardization. Plastics-Polyamides-Determination of viscosity Number, ISO 307, second edition 1984-05-15).

The time needed for the post-condensation can be a predetermined time or can be determined by the moment at which a material with a certain viscosity is obtained.

The process of the invention can be carried out in any reactor suitable for solid-state post-condensation of oligomeric polyesters. Suitable reactors are mentioned for instance in Nylon Plastic Handbook (Kohan, Hanser Verlag Publishers, Munich, 1995, pages 28-29) and references cited therein, along with Kunststof Handbuch, Band 3/4, Polyamiden (Vieweg/Muller, Carl Hanser Verlag, München, 1998, pages 651-652) and references therein. Examples of suitable reactors are, for instance, fixed bed reactors, moving bed reactors, rotary drums, tumble dryers, fluidized bed reactors and so on. Also, any process types suitable for solid-state post-condensation of the oligomeric or polymeric material used can be chosen for carrying out the process of the invention. Both batch as well as continuous operations can be practiced for this purpose. For the process of the invention carried out in a continuous operation a single flow-through reactor or a combination of more than one flow-through reactor might be used.

In an embodiment, the SSPC is conducted such that the number average molecular mass of the PBT powder is increased. In an embodiment, the number average molecular mass of the PBT powder processed by SSPC is from 10 000 g/mol to 50 000 g/mol, or from 20 000 g/mol to 40 000 g/mol. Inventors have surprisingly found that when repolymerizing the oligoester or OBT powder in the manner described according to this step has the surprising effect of inducing a larger gap between the melting point onset temperature and the crystallization onset temperature, along with causing the PBT (or copolymer thereof) powder produced therefrom to have a higher melting temperature than other known PBT (or copolymers thereof) powders. These properties both result in a PBT or PBT-based powder that possesses superior processability in additive manufacturing processes, such as MJF or SLS.

In alternative embodiments, it is possible to introduce one or more additives. A polymer composition is formed by the addition of at least one additive to the low molecular weight polymer or the post condensation polymer powder formed as described above for either fresh or recycled polymer powders, or combinations thereof. Such additives may be any suitable additive used for 3D printing without limitation, such as flame retardants, flow aids, fillers, pigments, and stabilizers. Suitable flow aids include fumed silicas, precipitated silicas; suitable fillers include glass particles and glass fibers (having a length of no more than 100 μm, but preferably less), glass beads, metal particles, and ceramic particles, suitable pigments include titanium dioxide, particles based on rutile, particles based on anatase, carbon black particles, carbon fibers; and stabilizers such as heat stabilizers and UV-stabilizers.

The introduction of the additives can occur between the providing (a) and micronizing (b) steps, or between the combining (a) and emulsion solidifying (c) steps. If introduced at either of these points, the additives are said to be “molecularly mixed.” If the additive(s) introduced are solid, and the OBT is a liquid as is preferred, such a combination may be called “compounding.” Various flame retardants, for example may be suitably introduced to the liquid OBT at this stage. Other additives may be similarly utilized, as will be appreciated by the person having ordinary skill in the art to which this invention applies.

An advantage of the processes according the first aspect of the present invention includes the ability to compound or molecularly mix at this stage. Doing so with a (relatively) low molecular weight polyester in the oligomer stage (such as OBT) affords the creation of a brittle and functionalized oligoester, which can then be uniformly and easily milled. Such a uniformly milled powder resulting therefrom will yield well-flowing functionalized particles which provide significant advantages in an additive manufacturing process over known alternatives.

Alternatively, or additionally, the introduction of additives may occur between the micronizing (b) and SSPC (d) steps, or between emulsion solidifying (c) and SSPC (d) steps. If the introduction occurs between steps (b) and (d), or between steps (c) and (d), the mixture will be less homogeneous, and such additives will hardly be present in the core of the OBT structure. Various antioxidants, for example, may be suitably introduced to the OBT powder at this stage. Other additives may be similarly utilized, as will be appreciated by the person having ordinary skill in the art to which this invention applies.

Furthermore, if a dry blend is to be created, further additives may be included in the powder after all steps according to the first aspect of the present invention.

A variety of additives are known that can be incorporated into powder compositions according to the present invention at one or more of the aforementioned process stages. Suitable additives to powders for additive manufacturing according to various embodiments of the invention include, for example, flow modifiers (other than the monomeric, oligomeric, or polymeric flow modifiers described elsewhere herein), fillers (including dispersed reinforcing materials such as chopped or milled glass fibers, chopped or milled carbon fibers, nano-fillers, clays, wollastonite and micas, as well as continuous reinforcing materials), pigments, processing aids (such as mold release agents), stabilizers (such as antioxidants and UV stabilizers), plasticizers, impact modifiers, and carrier polymers.

Other examples of fillers which are known and commonly used in thermoplastic resin compositions include mineral fillers such as clay, mica, talc, and glass spheres or beads. Reinforcing fibers are for example glass fibers. An advantage of a resin composition comprising glass fibers is its increased strength and stiffness, particularly also at higher temperatures, which allows use at temperatures up to close to the melting point of the polymer in the associated composition.

Inorganic substances are especially suitable as fillers because of their tendency to impart water-resistance, heat-resistance, and robust mechanical properties into the composition. In an embodiment of the invention, the filler is inorganic and comprises ceramics such as silica (SiO₂) nanoparticles, i.e., those particles having a mean particle size of from between 1 nanometer (nm) to 999 nm, or microparticles, i.e., those particles having a mean particle size of between 1 micrometer (μm) to 999 μm. Average particle size may be measured using laser diffraction particle size analysis in accordance with ISO13320-1. Please see U.S. Pat. No. 6,013,714 for further examples of silica nanoparticles.

In other embodiments of the invention, alternative inorganic filler substances may be used, such as those containing glass or metal particles. Certain non-limiting examples of such substances include: glass powder, alumina, alumina hydrate, magnesium oxide, magnesium hydroxide, barium sulfate, calcium sulfate, calcium carbonate, magnesium carbonate, silicate mineral, diatomaceous earth, silica sand, silica powder, oxidation titanium, aluminum powder, bronze, zinc powder, copper powder, lead powder, gold powder, silver dust, glass fiber, titanic acid potassium whiskers, carbon whiskers, sapphire whiskers, verification rear whiskers, boron carbide whiskers, silicon carbide whiskers, and silicon nitride whiskers.

In an embodiment, however, a powder composition according to the present invention is substantially devoid of any fillers at all. The absence of fillers may be beneficial because it ensures improved workability (i.e. flowability, surface finish) of the sintered products formed therefrom.

Suitable impact modifiers are rubber-like polymers that not only contain apolar monomers such as olefins, but also polar or reactive monomers such as, among others, acrylates and epoxide, acid or anhydride containing monomers. Examples include a copolymer of ethylene with (meth)acrylic acid or an ethylene/propylene copolymer functionalized with anhydride groups. The advantage of impact modifiers is that they do not only improve the impact strength of the resin composition but also contribute to an increase in viscosity. A suitable impact modifier is, for example, a maleic anhydride functionalized polyolefin.

Colorants, such as pigments or dyes, may optionally also be included in various embodiments. As colorants, for example, carbon black or nigrosine can be employed. EP 2 935 430 describes various other common pigments, which may be used suitably herein, including titanium dioxide in one or more of its three crystalline forms (rutile, anatase, and brookite), ultramarine blue, iron oxides, bismuth vanadates, effect pigments including metallic pigments such as aluminum flake and pearlescent pigments such as micas, and organic pigments, for example phthalocyanines, perylenes, azo compounds, isoindolines, quinophthalones, diketopyrrolopyrroles, quinacridones, dioxazines, and indanthrones.

The composition may additionally include one or more stabilizers. The presence of stabilizers is optional. Stabilizers are known per se and are intended to counter deterioration as a result of the effects of for example heat, light and radicals thereby formed. Known stabilizers that can be applied in the composition are for example hindered amine stabilizers, hindered phenols, phenolic antioxidants, copper salts and halogenides, preferably bromides and iodides, and mixtures of copper salts and halogenides, for example copper iodide/potassium iodide compositions and also phosphites, phosphonites, thioethers, substituted reorcinols, salicylates, benzotriazoles, hindered benzoates, and benzophenones. Preferably, the stabilizer is chosen from the group consisting of inorganic, hindered phenolic oxidant, hindered amine stabilizer and combinations thereof. More preferably, the stabilizers are a combination of inorganic stabilizer, a phenolic antioxidant and a hindered amine. In an embodiment, if the composition includes a stabilizer constituent, such constituent is present by weight, relative to the entire composition, from about 0.05 wt. % to about 2.0 wt. %, or from about 0.1 to 1.5 wt. %, or from 0.3 wt. % to 1.2 wt. %.

In an embodiment, the resin composition also includes one or more lubricants. Such substances include long chain fatty acids, especially stearic acid or behenic acid, salts thereof, especially Ca or Zn stearate, as well as their ester derivatives or amide derivatives, in particular ethylene-bis-stearylamide, montan waxes and low molecular weight polyethylene or polypropylene waxes. In an embodiment, suitable lubricants include esters or amides of saturated or unsaturated aliphatic carboxylic acids having 8 to 40 carbon atoms with saturated aliphatic alcohols or amines having from 2 to 40 carbon atoms, and metal salts of saturated or unsaturated aliphatic carboxylic acids with 8 to 40 carbon atoms used with ethylene-bis-stearylamide, and calcium stearate.

The aforementioned lists of additives are not intended to be limiting, and any other suitable additive may be employed as is generally known to those of skill in the art to which this invention applies. Further such examples include UV stabilizers, gamma ray stabilizers, hydrolysis stabilizers, thermal stabilizers, antistatic agents, emulsifiers, nucleating agents, drip agents (such as polytetrafluoroethylene or polyvinylpyrrolidone), and plasticizers.

If included, the additives described herein may be used singly or in combinations of two or more, and may be compounded with, molecularly mixed, or dry blended with the powders for additive manufacturing according to the present invention to form a polymer powder composition. Preferably, the PBT powder according to the present invention is present in the polymer composition in an amount in the range from 1 to 99 wt. % relative to the total weight of the polymer powder composition. The polymer powder composition can further comprise from 0.001 wt. % to 80 wt. %, or from 0.1 wt. % to 60 wt. %, or from 0.5 wt. % to 25 wt. % of additives, relative to the total weight of the polymer composition.

A second aspect of the current invention is a process of forming a fresh polymer powder suitable for 3D printing in accordance with the present invention which utilizes the steps of milling a thermoplastic polyester polymer, preferably a thermoplastic polyester polymer having a number average molecular mass in a range from 500 to 10 000 g/mol, or from 500 to 6000 g/mol, optionally, emulsion solidifying the thermoplastic polyester polymer, and then subjecting the milled powder to solid-state post condensation to increase the molecular weight, preferably in a range of 8000 to 60 000 g/mol, or from 10 000 to 50 000 g/mol.

The thermoplastic polyester polymer according to the second aspect include semi-aromatic thermoplastic polyesters such as poly(alkylene terephthalate)s, polybutylene terephthalate (PBT), polytrimethylene terephthalate (PTT), polyethylene terephthalate (PET), polybutylene naphthalate (PBN), polybutylene succinate (PBS), polyethersulfone (PES), polycyclohexane dimethylene terephthalate (PCT), and poly(alkylene naphthanate)s, such as polyethylene naphthanate (PEN), and any copolymers and any mixtures thereof or copolymers thereof with a minority content of another dicarboxylic acid or diol. In a preferred embodiment, however, the thermoplastic polyester polymer comprises, consists essentially of, or consists of PBT or copolymers thereof. The polyester may be formed via a (trans)esterification reaction. In various embodiments, any polyester powders, including those mentioned above, may be produced in accordance with any of the embodiments of the first aspect of the invention as well.

The thermoplastic polyester polymer according to the second aspect may be formed using any of the synthesis steps (combining, milling, SSPC) described according to any of the embodiments of the first aspect of the invention.

The process of (trans)esterification, milling, and SSPC results in a polymer powder having a Tₘ, onset of 215 to 260° C., or from 220 to 245° C., and a T_{c}, onset of 180 to 195° C. with a sinterability region of at least 10° C., or at least 11° C., or at least 12° C., or at least 13° C., or at least 14° C., or at least 15° C., or at least 20° C., or at least 25° C., or between 14-40° C., or between 15-35° C., or between 20-35° C., or between 25-35° C., or between 15-25° C., or between 15-20° C., or between 30-40° C., or between 35-40° C.

In one exemplified embodiment, oligobutyl terephthalate (OBT) is formed by the trans-esterification of dimethyl terephthalate (DMT) with 1,4-butanediol (BD).

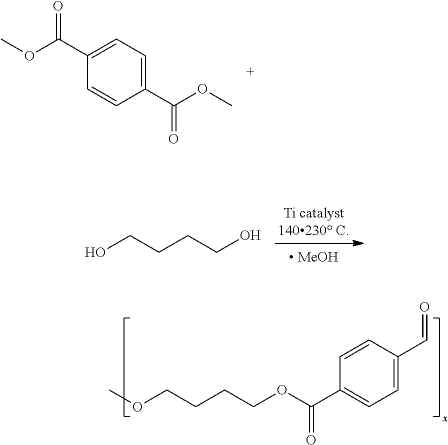

The OBT has a number average molecular mass (Mₙ) from 1000 g/mol to 6000 g/mol, or from 1000 g/mol to 5000 g/mol, or from 2000 g/mol to 4000 g/mol.

In this example, the OBT is then milled at room temperature to provide a flowing powder having a D50 particle size in a range of 30 to 60 μm measured by laser diffraction. The OBT powder is then subjected to solid-state post condensation to form a PBT powder having a number average molecular mass (Mₙ) of 20 000-50 000 g/mol.

A third aspect of the invention is a polybutylene terephthalate-based (PBT-based) powder, or a polymer powder comprising PBT or copolymers thereof, for 3D printing having a D50 particle size in the range of 40 to 50 μm, a number average molecular mass (Mₙ) from 20 000 g/mol to 40 000 g/mol, and a melting point onset temperature (Tₘ) of at least 210° C., or at least 220° C., or at least 225° C.

PBT-based powders for additive manufacturing according to the third aspect of the invention may be processed according to any method to reach the desired final powder characteristics, which include specified particle size distribution, molecular mass, and melting point onset temperature (Tₘ, onset) values. In a preferred embodiment, however, the methods and processes described elsewhere herein in a description of the embodiments of the first or second aspects of the invention are used to create the PBT-based powder according to the third aspect.

It is known to those skilled in the art that specific particle size distributions may facilitate optimal processability and flowability in additive manufacturing processes. Therefore, in an embodiment according to the third aspect of the invention, the PBT-based powder possesses a D50 particle size in the range of 20 to 50 μm, or from 40 to 50 μm. Excessively small particles, such as those below 20 μm, inhibit the flowability of the powder particles. Conversely, the ultimate object resolution suffers if the particles tend to become too large, such as above 50 μm. Furthermore, particles that are too large also tend not to pack sufficiently, and therefore voids may be introduced into the objects fused therefrom.

For particle size distributions the median is called the D50 (or x50 when following certain ISO guidelines). The D50 is the size (specified herein in microns unless otherwise stated) that splits the distribution with half above and half below this diameter. As used in embodiments of the third aspect herein, the particle size distribution and D50 particle size are determined according by laser diffraction particle size analysis in accordance with ISO 13320-1. Other related terms correspond to the median value of other ways of analyzing a distribution of particles. The Dv50 (or Dv0.5), for instance, is the median for a volume distribution. Likewise, Dn50 is used for number distributions, and Ds50 is used for surface distributions. Since the primary result from laser diffraction is a volume distribution, the default D50 cited is the volume median and D50 typically refers to the Dv50 without inducing the “v.”

Similarly, PBT-based powders according to the third aspect have prescribed molecular mass values. The PBT-based powder according to this aspect, therefore, possesses a number average molecular mass from 20 000 g/mol to 40 000 g/mol. PBT-based powders with exceptionally-low molecular weight, especially values of 10 000-20 000 g/mol or less, tend to produce three-dimensional objects with inferior mechanical properties. On the other hand, if the molecular mass is too large, such as 40 000-60 000 g/mol or larger, the resulting viscosity becomes too high for sufficient processability in that particle consolidation/sintering becomes inhibited.

Yet another characteristic of the PBT-based powders according to the third aspect of the invention is possession of Tₘ, onset value of at least 210° C., or at least 220° C., or at least 225° C., or from 220° C. to 250° C., or from 225° C. to 240° C., or from 220° C. to 230° C., or from 235° C. to 250° C., or from 225° C. to 230° C. Tₘ, onset values at or above these limits represent an increase over known PBT-based powders for additive manufacturing. Presuming a similar crystallization temperature, the relative increase in melting point onset temperature naturally results in a larger sinterability region of the powders of the current invention.

As used throughout this text, the values for Tₘ, onset, along with T_{c}, onset, are determined by the method prescribed in ISO 11357-1 (2009). Tₘ, onset, which is referred to in the ISO 11357-1 method as T_{i,m}, is measured by determining the first detectable departure (such as 0.1 mW) of the curve from an extrapolated start baseline of the melting peak curve as the material to be evaluated is heated, as evidenced by differential scanning calorimetry (DSC) during the first heating cycle, at a constant heating rate of 10° C. per minute. T_{c}, onset is determined in related fashion per ISO 11357-1, and which is referred to therein as T_{f,c}, and represents the last detectable departure of the curve from an extrapolated end baseline of the crystallization peak curve of the material to be evaluated.

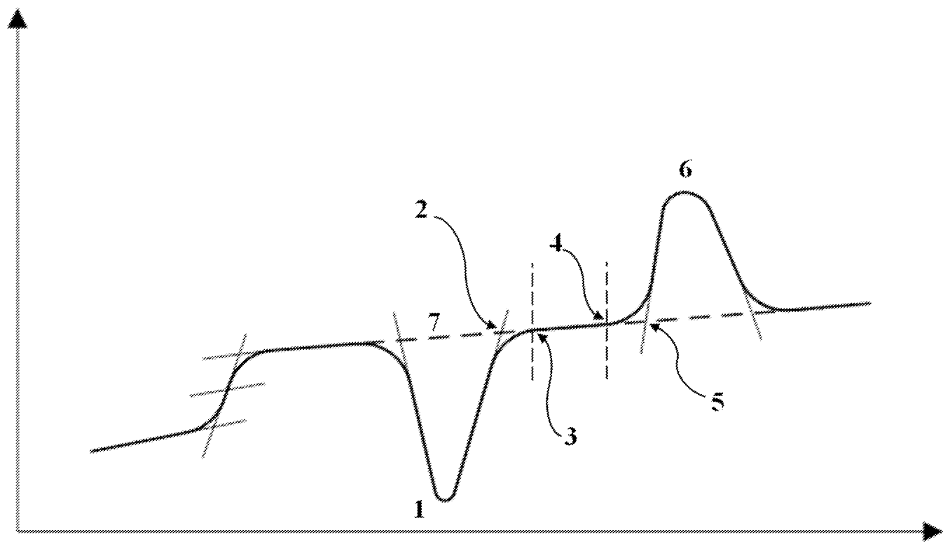

A hypothetical DSC curve having points of relevance as specified in ISO 11357-1 (2009) is depicted in FIG. 1. Turning to FIG. 1, the thermograph depicts the measured heat flow rate (also referred to as dQ/dt) on the y-axis with respect to the sample being evaluated as a function of temperature on the x-axis. Point 1 in this graph represents the measured T_{c} value, which is interchangeably referred to as T_{p,c} in ISO 11357-1. In either case, this point represents the greatest negative distance (i.e. below) between the curve and the interpolated baseline 7. On the other hand, the greatest distance above the interpolated baseline 7 and the curve represents the melting point temperature Tₘ (equivalent to T_{p,m}) 6. Points 2 (T_{ef,c}) and 5 (T_{ei,m}) represent points of intersection of extrapolated end baselines and tangents, and extrapolated start baselines and tangents drawn at point of inflection of a step, respectively. These points have been used by others to determine sinterability regions, although they are not used for such purpose herein for reasons described below. As can be seen, a somewhat narrower window is defined by the region between points 3 and 4 (and as aided visually by the region between the proximate vertical dashed lines), which represent the T_{c}, onset and Tₘ, onset points, respectively (and referred to in the ISO method as T_{f,c} and T_{i,m}).

With Tₘ, onset and T_{c}, onset values measured, the sinterability region of the powder, as defined herein, would be determined by subtracting the value of the temperature at 4 (T_{c}, onset) from the value at 3 (Tₘ, onset) (which is equivalent to T_{i,m} minus T_{f,c} per ISO 11357-1). The PBT powder of the third aspect possesses specified sinterability regions. As stated previously, by maintaining a sinterability region which is higher than known PBT powders for additive manufacturing, powders of the current invention facilitate improved ease of use in the additive manufacturing process with which such particles are associated, such as selective laser sintering or multi-jet fusion processes. Furthermore, as stated, powders with a larger sinterability region will more readily yield the production of three-dimensional components with higher dimensional accuracy, less warpage, curl, and deformation, and with improved construction and homogeneity. It is believed that characterizing “sinterability region” as defined herein is a superior proxy to real-world usability than other methods which take points higher and lower on the melting and crystallization curves, respectively. This is because even though powder theoretically may continue to be operable at temperatures further along the melting curves, in practice some portion of applied powder may begin agglomeration even at these early phases along the melting point curve. Therefore, to ensure optimal printability, it would be helpful to know the precise regions within which the risk of any such agglomeration or powder degradation could be avoided to the maximum extent possible. Other methods, which ostensibly list a larger window of operability (such as taking the difference between T_{ei,m} and T_{ef,c} per ISO 11357-1), do not give a true indication of the range within which risk of part warpage or curl would be minimized. The various points germane to the foregoing are depicted in FIG. 1.

In an embodiment, therefore, the sinterability region (ΔT=(Tₘ onset−T_{c}, onset) of the PBT-based powder is at least 14° C., or at least 15° C., or at least 20° C., or at least 25° C., or between 14-40° C., or between 15-40° C., or between 20-40° C., or between 20-30° C., or between 25-30° C., or between 15-25° C., or between 15-20° C.

PBT-based powders according to the third aspect may be provided as a kit of materials, or they may include one or more additives. In an embodiment, the PBT-based powder is dry blended with one or more additives. In another embodiment, the PBT-based powder is a polymer compound powder. Additives, including flame retardants, flow aids, fillers, pigments, stabilizers, and glass fillers, are common, and may be employed alone or in any combination as is exigent for the desired end-use application of the three-dimensional part created therefrom. In fact, any of the additives described above relating to embodiments of the first aspect of the invention may be employed in powders according to this aspect as well. Such additives may be incorporated or added to the polymer at any of the stages or steps, and in any of the fashions described elsewhere herein as well, as will be appreciated by the skilled artisan.

The present invention is further related to recycling waste powder to provide polymer powder suitable again for 3D printing. The process recycles used and unused powders as well as printed parts in SLS, HSS and/or MJF processes to printable powders.

Accordingly, a fourth aspect of the current invention is a process of recycling PBT-based powder obtained from 3D printing comprising: (a) providing a quantity of PBT-based powder; (b) depolymerizing the PBT-based powder to form an oligomeric polyester with a number average molecular mass from 500 g/mol to 5000 g/mol; (c) optionally, removing additives or monomer fragments; (d) optionally, introducing new additives; (e) milling the oligomeric polyester to form a powder preferably having a D50 particle size in the range of 1 to 650 μm, or more preferably from 40 to 50 μm; and (f) subjecting the oligomeric polyester powder to solid-state post condensation to form a recycled PBT-based powder.

Due to the intrinsic nature of 3D printing processes, a predominant part or portion of the provided powder will not be printed into the predetermined pattern. Regardless, the printing process still imparts several external stimuli upon the unused (or partially used) powder such that its melting characteristics may become irreversibly changed. Depending on the nature of the additive manufacturing process employed, these stimuli may include a prolonged (such as 1-24 hours or more) exposure to high temperatures, such as greater than 150° C.; oxygen and other gases which may oxidize or otherwise react with a portion of the powder; or, especially as in the case of MJF processes, contaminants introduced by processing fluids, including detailing fusing agents. After such exposure, conventional powders, including most polycondensates, polyamides, and polyesters, suffer an unacceptable narrowing of the sinterability region to be suitable for re-use. The processing window afforded by such powders remains unacceptable even after regrinding.

Surprisingly, inventors have discovered that subjecting fused or partially fused powder to a process in accordance with the fourth aspect of the invention facilitates the restoration of the powder's original sinterability region, or in the alternative, a restoration of a sinterability region that is compatible with the machine's specific minimum required processing window for further operation. This enables powders processed according to the invention to possess enhanced recyclability and/or reusability relative to other powders, especially conventional PBT-based powders.

In accordance with embodiments of the fourth aspect, the provided PBT-based powder is subjected to a step of depolymerization to form an oligomeric polyester with a number average molecular mass from 500 g/mol to 5000 g/mol. The waste powder is then subjected to a partial depolymerization process such as glycolysis, methanolysis, or hydrolysis to reduce the molecular weight of the waste powder to less than 5000 g/mol. For example, the high molecular weight polyester is contacted with a glycol such as ethylene glycol to produce oligomers and/or monomers of the polyester or a semi-crystalline polyester. Recovery of polyester waste may be accomplished by glycolysis of the polyester with excess ethylene glycol at elevated temperatures to form bis(2-hydroxyethyl)terephthalate, and low molecular weight polymers thereof, for recycling in the process indicated elsewhere herein, above.

Such processes for the depolymerization of polyesters, albeit not necessarily for the production of powders for suitability in 3D printing processes, are known. Such processes are described in, i.a., U.S. Pat. Nos. 4,078,143 and 6,410,607.

Next, the process of recycling PBT-based powders according to the fourth aspect of the invention includes the optional steps of removing additives and/or monomer fragments. Particulate additives include the types described elsewhere herein, including but not limited to carbon black, glass fibers, glass beads, pigments, or flame retardants. They may be removed by any known technique, including filtration, decantation, or other separation techniques. Furthermore, degraded monomer fragments may be removed by filtration or distillation techniques as will be appreciated by those having ordinary skill in the art to which this invention applies. Inventors have found that filtration is especially suitable for the removal of particulate additives and/or degraded monomer fragments of lower molecular weight, such as those with a number average molecular mass (Mₙ) of less than 500 g/mol, or less than 400 g/mol.

After removal of additives and/or monomer fragments, it is possible to add fresh additives to the oligomeric polyester. Any of the methods described elsewhere herein for introducing the additives, whether added as a dry blend, compounded, or molecularly mixed, may be suitable in embodiments of this aspect as well. Furthermore, any suitable additive may be introduced, including those already mentioned elsewhere herein.

In accordance with embodiments of the fourth aspect, the oligomeric polyester next undergoes a milling or grinding step to facilitate the creation of a particle size suitable for, after solid-state post condensation, use as a recycled/reused powder in an additive manufacturing process. The milling can be done at or around room temperature, e.g. 10 to 30° C. The milling may be any suitable milling such as jet milling. The milling may be carried out in a pinned-disk mill, a fluidized-bed opposed jet mill, baffle-plate impact mills and further treated as discussed above. The resulting D50 particle size is from 1 to 650 μm, or more preferably from 1 to 400 μm, such as for example, from 10 to 200 μm, 20 to 100 μm, or most preferably from 40 to 50 μm. Such particle sizes may be measured by a variety of techniques, including dynamic or static light scattering, or via other SEM/TEM methods. In an embodiment, the particle size is measured by laser diffraction particle size analysis in accordance with ISO 13320-1.

Additionally, in embodiments according to the fourth aspect, the milled powder is subjected to solid-state post condensation (SSPC) to increase its molecular weight. Such SSPC techniques used according to embodiments of the fourth aspect of the invention are the same as those described elsewhere herein at, e.g., the embodiments of the first aspect of the invention. The resulting recycled polymer powder may possess a D50 particle size in a range of 40 to 50 μm, a number average molecular mass value of 20 000-40 000 g/mol, and a sinterability region of at least 25° C.

In one specific embodiment, waste powder obtained from 3D printing is recycled by depolymerizing the PBT to form semi-crystalline polyester OBT; the OBT is then milled to form a powder having a D50 particle size in a range of 40 to 50 μm; and finally, the OBT powder is subjected to solid-state post condensation to form the recycled PBT powder.

Powders according to the present invention, when processed in accordance with the above, may exhibit improved recyclability or reusability.

A fifth aspect of the invention is a method of forming a three-dimensional object comprising the steps of: (a) providing a layer of a particulate composition, the particulate composition comprising a polyester powder having a melting point onset temperature (Tₘ, onset), a crystallization onset temperature (T_{c}, onset), and a sinterability region (Tₘ, onset−T_{c}, onset), wherein the sinterability region of the polyester powder is greater than 14° C., when determined in accordance with ISO 11357-1 (2009); (b) optionally, selectively depositing a liquid composition onto the layer of the particulate composition, wherein at least one of the particulate composition or liquid composition comprises a fusing agent; (c) applying electromagnetic radiation to at least one of: (i) a specified location on the layer of the particulate composition, or (ii) a location at which the liquid composition which has been selectively deposited onto the particulate composition; wherein the particulate composition undergoes melting in at least some of the locations where the electromagnetic radiation and/or the liquid composition has been applied to form a fused section in accordance with computer data corresponding to a portion of a three-dimensional object to be formed; and (d) repeating steps (a), optionally (b), and (c) a plurality of times to form a fused three-dimensional object.

In an embodiment according to the fifth aspect, the polyester powder comprises, consists essentially of, or consists of polybutylene terephthalate (PBT). In another embodiment, the polyester powder comprises, consists essentially of, or consists of a PBT copolymer. The PBT copolymer may be any copolymer having at least one PBT block and/or containing at least 5%, or at least 10% molar equivalents of glycols. In an embodiment, the PBT copolymer possesses a block which is the reaction product of a dimer fatty acid, butanediol, dimethyl terephthalate, or polytetrahydrofuran.

The polymer particles as defined in the present invention are particularly suitable for a variety of rapid prototyping/rapid manufacturing methods, including, but not limited to: selective laser sintering (SLS), powder/binder methods, and multi-jet fusion (MJF). In the SLS process, the polymer particles are introduced in a chamber and are selectively briefly exposed to a laser beam, and the particles impacted by the laser beam therefor melt. The molten particles coalesce and rapidly solidify again to give a solid mass. This process can produce three-dimensional structures simply and rapidly by constantly applying new layers and repeatedly exposing them to laser light to melt and subsequently coalesce in the form of the three-dimensional object.

Other additive manufacturing methods in which the powders of the present invention may be suitably incorporated are high speed sintering (HSS) and Multi jet fusion (MJF). Such methods utilize multiple jets that deposit successive layers of infrared absorbing fluids onto powder material, after which an exposure of energy, typically infrared energy, is applied to selectively melt the powder layer. Still another germane additive manufacturing process is electrophotography 3D-printing. This method employs a rotating photoconductor that builds the object layer-by-layer from the base.

Whatever the process, each such 3D-printing method utilizes a similar arrangement of a moveable powder bed used for the production of the object. Furthermore, each process requires similar material performance of the powder being utilized therewith, because, despite the slightly differing heating mechanisms employed, similar stresses will be applied to the object being constructed in each case. Accordingly, in an embodiment, the polymer particles of any of the stated aspects of this invention, or any particles formed by any of the stated aspects of this invention, are used in an SLS process, or an MJF process, or an HSS process, or a powder/binder process, or an electrophotography 3D printing process.

Another known additive fabrication technique for which the particles of the present invention are considered suitable is a powder/binder type system, such as the one disclosed in U.S. Pat. No. 5,204,055. In this technique, a layer of a powder material is first formed. A liquid binder is then deposited onto a layer of a powder material in selected regions in accordance with computer data corresponding to the shape of at least a portion of a three-dimensional object. The liquid binder causes the powder material to become bonded in the selected regions. The steps of forming layers of powder material and depositing the liquid binder in selected regions of the layer of powder material are repeated a predetermined number of times to produce a three-dimensional object. The powder may be solid or porous and may be a ceramic, metallic, or plastic material. In relevant embodiments of the present invention, however, the powder used is a polyester powder as described elsewhere herein, preferably a PBT powder according to embodiments of the third aspect of the invention, or a PBT powder formed by any of the embodiments of the first, second, or fourth aspects of the invention.

Therefore, in an embodiment, the invention involves a method of forming a three-dimensional object comprising the steps of: forming a layer of a particulate composition; selectively depositing a liquid composition onto the layer of the particulate composition in accordance with computer data corresponding to the shape of at least a portion of a three-dimensional object, wherein at least one of the particulate composition or liquid composition comprises a fusing agent; applying electromagnetic radiation to at least one location of the layer of the particulate composition where the liquid composition has been deposited, wherein the particulate composition undergoes melting in the at least one location; and repeating the aforementioned steps a plurality of times to form a three-dimensional object.

The methods according to the fifth aspect utilize a powder as described in, or created by, any of the embodiments of any of the first four aspects of the invention. Advantageously, the methods according to the fifth aspect preferably employ a powder manufactured according to any of the embodiments of the first or fourth aspects, or any of the powders according to any of the embodiments of the second or third aspects. By way of example, the process includes a powder having one or more of the following characteristics: a size distribution D50 in the range of 40 to 50 μm; a number average molecular mass (Mₙ) from 10 000 g/mol to 50 000 g/mol, or from 20 000 g/mol to 40 000 g/mol; a melting point onset temperature (Tₘ, onset) of at least 210° C., or at least 220° C., or at least 225° C., or from 220° C. to 250° C., or from 225° C. to 240° C., or from 220° C. to 230° C., or from 225° C. to 240° C., or from 225° C. to 230° C.; or a sinterability region of at least 10° C., or at least 11° C., or at least 12° C., or at least 13° C., or at least 14° C., or at least 15° C., or at least 20° C., or at least 25° C., or between 14-40° C., or between 15-35° C., or between 20-35° C., or between 25-35° C., or between 15-25° C., or between 15-20° C., or between 30-40° C., or between 35-40° C. The powder used may be new, or it may have been previously used in an additive manufacturing process and recycled per the process outlined elsewhere herein, supra. Such recycled PBT powder may have been used in 1, 2, 3, 4, 5, or more previous additive manufacturing processes and recycled according to the process described elsewhere herein before being used in embodiments of methods of the fifth aspect.

The formation of three-dimensional objects from polymer powder may be facilitated or aided with the inclusion of additional materials. Such materials, which may be particulate solids or liquids, may be interspersed within the polymer powder, or may be deposited thereon, such as by selective jetting. Fusing agents, which are described in, i.a., WO-A-2017/196361, are a commonly-included example of additional materials which are used extensively in MJF or HSS processes. Fusing agents typically comprise, as an active ingredient, one or more energy absorbers, or components that are capable of absorbing electromagnetic radiation in order to produce heat. They may also include thermal and/or photo initiators. Such components may absorb electromagnetic radiation in the UV, UV-vis, visible, near-infrared, or infrared portions of the spectrum. When applied in selective locations, these fusing agents can impart melting only in the regions in which they have been applied and/or in which electromagnetic radiation has been applied to the polymer powder.

Non-limiting examples of fusing agents include pigments such as carbon black, tungsten bronzes, molybdenum bronzes, and metal nanoparticles, phosphates having a variety of counterions such as copper, zinc, iron, magnesium, calcium, and strontium, and the like, as well as silicates, especially those having the same or similar counterions as phosphates. Additionally, laser dyes and cyclic lactone dye precursors may be used. Near-infrared absorbing dyes may further be used, and include examples such as aminium dyes, tetraaryldiamine dyes, cyanine dyes, pthalocyanine dyes, dithiolene dyes, and combinations thereof.

Additionally, conjugated polymers may be used as fusing agents. Examples of near-infrared absorbing conjugated polymers include poly(3,4-ethylenedioxythiophene)-poly(styrenesulfonate) (PEDOT:PSS), a polythiophene, poly(p-phenylene sulfide), a polyaniline, a poly(pyrrole), a poly (acetylene), poly(p-phenylene vinylene), polyparaphenylene, or combinations thereof.

The amount of fusing agent can vary depending on the component or components used. In an embodiment, the fusing agent can be from 0.1 wt. % to 20 wt. %. In one example, the concentration of energy absorber in the fusing agent can be from 0.1 wt. % to 15 wt. %. In another example, the concentration can be from 0.1 wt. % to 8 wt. %. In yet another example, the concentration can be from 0.5 wt. % to 2 wt. %. In a particular example, the concentration can be from 0.5 wt. % to 1.2 wt. %.

Fusing agents may also include one or more or initiator capable of initiating polymerization of the resin component. These initiators include thermal initiators and photoinitiators.

Thermal initiators include, without particular limitation, thermal free-radical polymerization initiators and peroxides. Examples of thermal free-radical polymerization initiators include, but are not limited to, azo compounds such as, for example, azo isobutyronitrile (AIBN), 1,1′-azo-bis(cyclohexanenitrile), 1,1′-azo-bis(2,4,4-trimethylpentane), C—C labile compounds, such as benzopinacole, peroxides, and mixtures thereof.

Examples of peroxides potentially suitable as thermal initiators include for example, percarbonates (of the formula —OC(O)O—), peroxyesters (of the formula —C(O)OO—), diacylperoxides, also known as peranhydride (of the formula —C(O)OOC(O)—), dialkylperoxides or perethers (of the formula —OO—), hydroperoxides (of the formula —OOH), etc. The peroxides may also be oligomeric or polymeric in nature. Examples of organic peroxides are: tertiary alkyl hydroperoxides (such as, for instance, t-butyl hydroperoxide), other hydroperoxides (such as, for instance, cumene hydroperoxide), a ketone peroxide (perketones, being an addition product of hydrogen peroxide and a ketone, such as, for instance, methyl ethyl ketone peroxide, methyl isobutylketone peroxide and acetylacetone peroxide), peroxyesters or peracids (such as, for instance, t-butyl peresters, benzoyl peroxide, peracetates and perbenzoates, lauroyl peroxide, including (di)peroxyesters, perethers (such as, for instance, peroxy diethyl ether).

The thermal free-radical polymerization initiator may for example comprise a percarbonate, a perester or a peranhydride. Peranhydrides are for example benzoylperoxide (BPO) and lauroyl peroxide (commercially available as Laurox™). Peresters are for instance t-butyl per benzoate and 2-ethylhexyl perlaurate. Percarbonates are for example di-t-butylpercarbonate and di-2-ethylhexylpercarbonate or monopercarbonates.

Finally, photoinitiators for three-dimensional printing are also known, and are described in, i.a., U.S. Pat. No. 9,951,198.

The polymeric powders and fusing agents herein described may be present in one single composition/formulation, or they may be stored separately and applied to each other selectively during the additive manufacturing build process. Therefore, embodiments of the current invention are directed to a kit of materials, where the kit includes a combination of at least one of: (a) a polybutylene terephthalate (PBT)-based powder formed by the methods described elsewhere herein; the polybutylene terephthalate (PBT)-based powder described according to any of the embodiments elsewhere herein; or; or the polyester powder formed by the method of any of the previous embodiments described elsewhere herein; and (b) a fusing agent, wherein the fusing agent further comprises an energy absorber, a thermal initiator, or a photoinitiator.

### Examples

The examples which follow are intended as an illustration of certain preferred embodiments of the invention, and no limitation of the invention is implied. Table 1 describes the starting material and specific conditions under which each example or comparative example was subsequently processed. Table 2 provides a summary of the performance of each example/comparative example, including a listing of D50 particle size (expressed in microns, or μm), the melting temperature (Tₘ), peak crystallization temperature (T_{c}), melting point onset temperature (Tₘ, onset), crystallization onset temperature (T_{c}, onset), and sinterability region (Tₘ, onset−T_{c}, onset). Unless otherwise specified, all temperatures are expressed in degrees Celsius. The methods used for determining the foregoing measurements are specified below.

The examples herein were prepared via the preparation of several starting materials. Comparative example 1 and examples 2-3 were formed from a starting material referred to herein as “PBT-1.” PBT-1 is a pure polybutylene terephthalate powder which possesses a number average molecular mass of approximately 15 000 g/mol.

PBT-1 was provided by the reaction of 881.8 g of DMT and 516.4 g of BD with 0.1159 g of Mg(Oacetate)₂.4 H₂O and 10.55 g of a 40.22 mg/g TBT in BD solution as the catalyst system. Then, a 1.3-liter reactor equipped with mechanical stirrer, condenser and oil heating was loaded with all the aforementioned ingredients. Air was next removed by applying full vacuum to the reactor and using nitrogen to go to atmospheric pressure (which process was conducted 3 separate times). Then the temperature was increased to 210° C. over a period of 90 minutes, and the stirrer was started at 100 rpm. Methanol was liberated and collected via the condenser. When no more distillate had formed, the pressure was decreased to 300 mbar over a period of 15 minutes. After removing the methanol from the condenser vessel, the temperature was increased to 255° C. over a period of approximately 30 minutes, whereupon the vacuum was decreased to 7.5 mbar over approximately 30 minutes. When a torque of 1 Nm was reached, the stirring speed was decreased to 25 revolutions per minute (rpm). At 25 rpm, the polymerization reaction was stopped when a torque of 4 Nm was reached, and the reactor was then purged with nitrogen to atmospheric pressure. With the assistance of overpressure, the polymer strain coming from the reactor was then cooled in a water bath and cut into granules.

Comparative example 4 and examples 5-8 were derived from an oligomeric starting material, oligobutylterephthalate (OBT). Such OBT was formed by the (trans)esterification of dimethylterephthalate (DMT) with 1,4-butanediol (BD) as follows:

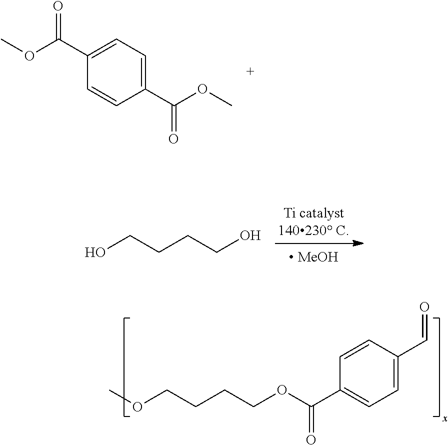

The OBT was made by adding 1.283 grams of a titanium(IV) butoxide (TBT) solution in BD (49.8619 mg/g TBT/BD), 40.322 mg of magnesium acetate tetrahydrate, 132.27 grams (680.8 mmol) of DMT, and (1.15 eq BD/DMT) of BD to a 200 ml reactor at room temperature. The reactor was heated to 220° C. and the reactor lid temperature was set to 80° C. After 20 minutes (with the solid approximately 80% molten), the stirrer was set at low speed (≈12 rpm). 10 minutes later (with a near complete dissolution at around 95%), the stirrer was set to 400 rpm. After 1 minute of stirring, the mixture became clear. The distillation started between 0 minutes and 4 minutes after the stirrer was set at high speed. After 1 hour (with approximately at least 85% having been distilled), the vacuum profile was started (60 minutes from atmospheric pressure to 50 mbar) and the reactor temperature was set to 230° C. When the desired vacuum profile was reached, the reactor content was quenched in 1 liter of water while stirring. The polymer was then dried overnight in an oven at 80° C. under vacuum.

The OBT possessed a number average molecular mass (M₁) of 3100 g/mol when measured according to the H-NMR method described below. Comparative example 4 and examples 5-7 were jet-milled at room temperature to provide a flowable powder having a D50 particle size in a range of 40 to 50 μm measured by laser diffraction (and specified individually in Table 2 below). Example 8 was alternatively micronized to form a flowable powder by means of a cryogenic milling step. The OBT of examples 5-8 were then subjected to solid-state post condensation as indicated according to the conditions specified in the following paragraph and Table 1 below to form a PBT powder having a number average molecular mass (Mₙ) of 20 000-40 000 g/mol, when measured according to the method described below. The methods for determining the quantitative values listed in Tables 1 and 2 are described below.

Specifically, solid-state post condensation was performed by loading a 250 nil baffled glass reactor rotating in an oil batch, after which 30 g of oligomeric PBT powder was added. Air was removed by applying full vacuum to the reactor and using nitrogen to go to atmospheric pressure (which process was conducted three separate times). The temperature, the vacuum, and the reaction times during the SSPC were varied as described in Table 1. At the end of the process, the reactor was cooled to room temperature under vacuum. Finally, the vacuum was released at room temperature and the flowable powder was isolated.

Comparative example 9 involved a portion of material that was already used in an additive manufacturing process. This material is referred to as “Used PBT” in Table 1 below. Here, the PBT powder (which itself was prepared in a process similar to the powder of example 8) was obtained after having spent at least 4 hours in a laser sintering printer set with a chamber temperature set to 200° C. The material was then sieved over a 200 μm filter and 100 g of which was added to a 200 ml glass reactor. Next, 3 g of 1,4-butandiol was added. The reactor was then closed, and air was removed by applying full vacuum to the reactor and using nitrogen to go to atmospheric pressure (which process was conducted three separate times). The reaction mixture temperature was then set to 250° C. When the reaction mixture was homogeneously molten (after approximately 1 hour as observed), the reactor content was quenched in 1 liter of water while stirring. The oligomeric PBT was then filtered and dried at 80° C. under a vacuum overnight. The material possessed a number average molecular mass (Mₙ) of approximately 4000 g/mol when measured according to the H-NMR method described below.

Example 10, which derived from a recycled version of Used PBT, and which is referred to as “Re-OBT” herein, involved first providing the recycled Used PBT material. Next, it was milled in an IKA A11 basic mill, after which a solid-state post condensation process was applied. The SSPC was performed by loading a 250 ml baffled glass reactor rotating in an oil batch and filled with 50 g of Re-OBT. Air was removed by applying full vacuum to the reactor and using nitrogen to go to atmospheric pressure (which process was conducted a total of 3 separate times). The specific temperature, the vacuum, and the reaction times during the SSPC were performed according to the conditions described in Table 1. At the end of the process, the reactor was cooled to room temperature under vacuum. Then, the vacuum was released at room temperature, and the flowable powder was isolated.

Example 11 utilized a starting material referred to herein as PBT copolymer 1. Such material was a thermoplastic copolyester created via the reaction of a dimer fatty acid (DFA) with butanediol (BD) and dimethyl terephthalate (DMT). The resulting copolymer comprises PBT “hard” segments which represent the reaction product of the butanediol with DMT and “soft” segments which represent the reaction product of the DFA with butanediol.

The PBT copolymer 1 was made by reaction of 685.3 g of DMT, 496.6 g of BD and 200 g of DFA with 0.3 g of Mg(Oacetate)₂.4 H₂O and 10 g of a 50 mg/g of Ti in BD (Ti as tetrabutoxytitanate) solution as the catalyst system. Then, a 1.3-liter reactor equipped with mechanical stirrer, condenser and oil heating was loaded with all the aforementioned ingredients. Air was next removed by applying full vacuum to the reactor and using nitrogen to go to atmospheric pressure (which process was conducted 3 separate times). Then the temperature was increased to 210° C. over a period of 90 minutes, and the stirrer was started at 100 rpm. Methanol was liberated and collected via the condenser. When no more distillate had formed, the pressure was decreased to 300 mbar over a period of 15 minutes. After removing the methanol from the condenser vessel, the temperature was increased to 240° C. over a period of approximately 30 minutes, whereupon the vacuum was decreased to 1.0 mbar over approximately 30 minutes. When a torque of 7 Nm was reached, the stirring speed was decreased to maintain this torque level. At 25 rpm, the polymerization reaction was stopped, and the reactor was then purged with nitrogen to atmospheric pressure. With the assistance of overpressure, the PBT copolymer strain coming from the reactor was then cooled in a water bath and cut into granules.

The resulting granules were then prepared into an oligomer via depolymerization. Such depolymerization could be accomplished by first drying the polymer for 16 hours under vacuum conditions at 80° C., and then by mixing the dried polymer with 3 wt. % (with respect to the total weight of the powder) of BD in a glass reactor with electrical heating and a stirrer. Next, the reactor would preferably be closed, with air removed by applying a full vacuum to the reactor and using nitrogen to increase the vacuum to atmospheric pressure (which process would preferably be conducted three separate times). After this, the reaction mixture temperature would preferably be set to 250° C. Once the reaction mixture became homogeneously molten (typically at around 1 hour), the reactor content would be quenched in 1 liter of deionized water while stirring. The resulting OBT copolymer would then be filtered and dried at 80° C. under vacuum overnight.

The resulting flakes were milled with a Retsch ZM-1 milling device (“ZM1”) with an internal 2 mm sieve. The obtained powder was not further milled or sieved to obtain the desired particle size distribution optimal for a 3D printing process, as it was merely used as such to proof of principle of the present invention.

Solid-state post condensation was then performed by loading a 25 ml round bottom flask rotating in an electrical oven and filled with 3 g of the OBT copolymer powder. Air was then removed by applying full vacuum to the reactor and using nitrogen to go to atmospheric (which process was performed three total times). The temperature, the vacuum, and the reaction times during the SSPC were set according to the conditions described in Table 1. At the end of the process, the reactor was cooled to room temperature under vacuum. Finally, at room temperature the vacuum was released and the flowable powder was isolated.

Example 12 utilized a starting material referred to herein as “PBT copolymer 2.” This material is a thermoplastic copolyester created via the reaction of a polytetrahydrofuran (having a supplier-claimed molecular weight of 1000 g/mol; herein referred to as “pTHF 1000”) with 1,4-butanediol (BD) and dimethyl terephthalate (DMT). The resulting copolymer comprises PBT “hard” segments which represent the reaction product of the butanediol with DMT and “soft” segments which represent pTHF 1000. PBT copolymer 2 was specifically formed by the reaction of 718.42 g of DMT, 477.3 g of BD, and 200 g of pTHF 1000 with 0.3 g of Mg(Oacetate)₂.4 H₂O 10 g of a 50 mg/g of Ti in BD (Ti as tetrabutoxytitanate) solution as the catalyst system.

The synthesis, the grinding and the SSPC of oligomer of example 12 was done in the same manner as that with respect to example 11.

Comparative example 13, meanwhile, utilized a starting material referred to herein as “PBT copolymer 3.” This material, which was also provided in granule form for further processing, is a thermoplastic copolyester created via the reaction of a polytetrahydrofuran (having a supplier-claimed molecular weight of 1000 g/mol; herein referred to as “pTHF 1000”) with butanediol, dimethyl terephthalate and dimethyl isophthalate (DMI). The resulting copolymer comprises PBT “hard” segments which represent the reaction product of the butanediol with DMT and “soft” segments which represent pTHF 1000.

PBT copolymer 3 was made by reaction of 45.6 g of DMT, 3.0 g of DMI 12.12 g of BD and 55 g of pTHF 1000 with 0.03 g Mg(Oacetate)₂.4 H₂O and 0.043 g of tetrabutoxytitanate as the catalyst system. The synthesis, the grinding and the SSPC of oligomer of example 13 was done in the same manner as with respect to example 11.

Example 14 utilized a starting material referred to herein as “PBT copolymer 4.” This material, which was also provided in granule form for further processing, is a thermoplastic copolyester created via the reaction of a polytetrahydrofuran (having a supplier-claimed molecular weight of 2000 g/mol; herein referred to as “pTHF 2000”) with butanediol and dimethyl terephthalate. The resulting copolymer comprises PBT “hard” segments which represent the reaction product of the butanediol with DMT and “soft” segments which represent the reaction product of DMT with pTHF 2000.

PBT copolymer 4 of example 14 was made via the reaction of 375.31 g of DMT, 244.3 g of BD and 598 g of pTHF 2000 with 0.3 g of Mg(Oacetate)₂.4 H₂O and 10 g of a 50 mg/g of Ti in BD (Ti as tetrabutoxytitanate) solution as the catalyst system.

The polymer granules were then subjected to a depolymerization step. In this step, 137.2 g of polymer was dried for 16 hours under a vacuum at 80° C. Next, the dried polymer was added to a 200 ml glass reactor with electrical heating and a stirrer, after which 1.69 g of BD was added. The reactor was then closed, and air was removed by applying full vacuum to the reactor and using nitrogen to go to atmospheric pressure (which process was conducted a total of 3 times). The reaction mixture temperature was set to 250° C. When the reaction mixture was homogeneously molten (approximately 1 h as observed), the reactor content was quenched in 1 liter of water while stirring. The resulting OBT copolymer was filtered and dried at 80° C. under vacuum overnight. The copolymer powder was then obtained via milling precooled copolymer flakes in liquid nitrogen in an IKA A11 basic mill.

The SSPC of oligomer of example 14 was done in the same manner as was performed with respect to example 11.

Example 15 depicts a compound of PBT and glass beads. This polymer compound could be created by first mixing PBT granules (the PBT powder of “PBT-1”) present at 70 parts by weight with glass beads (Microperl® 050-20-216 from Sovitec, having a D50 particle size of 20 microns) and 2.1 parts by weight of BD in a reactor with electrical heating and a stirrer. Next, the reactor would preferably be closed, with air removed by applying a full vacuum to the reactor and using nitrogen to increase the vacuum to atmospheric pressure (which process would preferably be conducted three separate times). After this, the reaction mixture temperature would preferably be set to 250° C. Once the reaction mixture became homogeneously molten (typically at around 1 hour), the reactor content would be quenched in 1 liter of deionized water while stirring. The resulting compounded PBT oligomer would then be filtered and dried at 80° C. under vacuum overnight.

After the material was provided (in the form of flakes), it was then milled with a Retsch ZM-1 milling device with an internal 2 mm sieve.

Solid-state post condensation was done by loading a 250 ml baffled glass reactor rotating in an oil batch and filled with 71 g of oligomeric PBT powder. Air was then removed by applying full vacuum to the reactor and using nitrogen to go to atmospheric pressure (which process was conducted a total of 3 separate times). The temperature, the vacuum, and the reaction times during the SSPC were maintained as is described in Table 1 below. At the end of the process, the reactor was cooled to room temperature under vacuum. Finally, the vacuum was released at room temperature and the flowable powder was isolated.

### Mₙ

Where specified, number average molecular mass (Mₙ) was determined by H-NMR based on the ratio of end-group and main chain signals. To accomplish this, approximately 15 mg of each sample was dissolved in a 1 ml mixture of deuterated chloroform (CDCl₃), which itself contained 5-10% of hexafluoroisopropanol-d2 (HFIP-d2). From the H-NMR spectrum, the relative amount of terephthalic acid and butane diol units, for example, was calculated as follows: for terephthalic acid, the aromatic C—H signals between 7.8-8.4 ppm represented the total amount of units present (either in main chain or at chain ends). In addition, the OCH₃ endgroup was observed at 4.0 ppm. Butanediol, by contrast, was quantified using the signals between 4.2-4.6 ppm and 2.0-2.2 ppm, both representing BD in the main chain, and using signals at 3.7-3.8 ppm and 1.7-1.8 ppm, each of which represented BD at chain ends.

The average amount of terephthalic acid and butane diol units per chain was then calculated from the ratio of the main chain to the end group signals, with the assumption that all polymer chains possessed exactly 2 endgroups, and further assuming all endgroups were either: —OH originating from BD, or —OCH₃ originating from DMT. The number average molar mass was then calculated by multiplying the average number of units by their corresponding molar mass.

Alternatively, where specified, number average molecular mass was determined by gel permeation chromatography (GPC) with a polymethylmethacrylate standard in a solution of hexafluoroisopropanol (HFIP) and 0.1 wt. % of potassium trifluoroacetate at 35° C. The separation columns used were provided by Polymer Standards Service GmbH (Germany). Three model PFG Linear XL 7 μm, 300×8.0 mm columns (particles size: 7 μm) with pre-column were then applied. The detector used, meanwhile, was a Malvern GPCMax V2001 solvent/sample module with Triple Detection Array 302, containing refractive index (RI), right-angle light scattering (RALS) and viscosity (IV) detection. Finally, the data acquisition and calculations were performed using Malvern OmniSEC 4.7.0 software.

The values for each sample were recorded and are presented in Table 1, below. Samples designated with the superscript “b” refers to the fact that the Mₙ of such sample was performed via H-NMR, whereas the Mₙ values of samples designated with the superscript “a” were determined via GPC.

### D50 Particle Size

D50 particle size was measured in accordance with ISO 13320-1 as mentioned elsewhere herein. The Particle Size Distributions (PSD) of powders from which D50 values were derived were measured using Laser Diffraction on a SYMPATEC HELOS system (model HELOS/H3982) with a RODOS dry dispersion unit, R5 4.5-875 μm. D50 represents the statistical volume median of the particles. The D50 values for the various samples were recorded and reported in Table 2 below. Values are reported in microns, unless otherwise noted.

### Tₘ, T_{c}, Tₘ, Onset, T_{c}, Onset, and Sinterability Region

Tₘ, T_{c}, Tₘ, onset, T_{c}, onset, and Sinterability Region were determined via differential scanning calorimetry (DSC). The DSC measurements were performed on a Mettler DSC823e equipped with a FS0812R0 sample robot and Mettler TS0800GC1 gas control. All samples were recorded in sealed aluminum pans. The calibration of the DSC instruments was carried out with indium. Then, the DSC thermograms of the materials (in amounts from 3 to 10 mg) were recorded at a scanning rate of 10° C. per minute, with a temperature range from −80 to 250° C. The data collection was carried out using STARe software.

Values for Tₘ, T_{c}, Tₘ, onset, T_{c}, onset, and Sinterability Region were then determined with the DSC thermographs in accordance with ISO 11357-3 (2009). First, T_{i,m} was determined by taking the first detectable departure of the curve from an extrapolated start baseline of the melting peak curve as the sample to be evaluated was heated, as evidenced by differential scanning calorimetry (DSC) during the first heating cycle, at a constant heating rate of 10° C. per minute. Furthermore, “the first detectable departure of curve from extrapolated start baseline” was defined as the point at which the thermograph illustrated at least a 0.1 mW deviation from the baseline. The values for T_{i,m} derived from this ISO method were recorded and are reported in Table 2 as Tₘ, onset.

T_{f,c} meanwhile, was then determined per the same ISO method, which represented the last detectable departure of the curve from an extrapolated end baseline of the crystallization peak curve of the material to be evaluated, wherein “last detectable departure” was defined as the point at which the deviation from the baseline became less than 0.1 mW. The values for T_{f,c} derived from this ISO method were recorded and are reported in Table 2 as T_{c}, onset.

In similar fashion, Tₘ and T_{c} were determined per the same ISO method as designated by T_{p,m} and T_{p,c} therein, respectively. These values are also reported in Table 2, below.

Finally, the sinterability region was determined by subtracting the value, on a sample-by-sample basis, of T_{c}, onset from Tₘ, onset, or from ISO 11357-3, T_{i,m}-T_{f,c}.

All values for Tₘ, Tₘ, onset, T_{c}, T_{c}, onset, and sinterability region as reported herein are expressed in degrees Celsius (° C.), unless otherwise noted.

TABLE 1

| | Starting | Compounded | Micronizing | Mn after | |
|---|---|---|---|---|---|
| Sample | Material | with | conditions | SSPC | Annealing/SSPC conditions |
| C1 | PBT-1 | None | Cryo-milled | 15100^{a} | None; starting material |
| 2 | PBT-1 | None | Mechanical | 20700^{a} | 20 hours (h) heating in three steps (210° C., 215° C., |
| | | | Cryo-milled | | & 220° C.), no vacuum applied |
| 3 | PBT-1 | None | Mechanical | No data | 7 h at 185° C. + 15 h at 210° C., vacuum at 0.8 |
| | | | Cryo-milled | | millibar (mbar) applied |
| C4 | OBT | None | Jet-milled | 3100^{b} | None; starting material |
| 5 | OBT | None | Jet-milled | 20400^{b} | 11 hat 185° C., followed by 6 h at 195° C., 2.6 mbar |
| 6 | OBT | None | Jet-milled | 36500^{b} | 7 h at 180° C., 25 h at 190° C., followed by 23 h at |
| | | | | | 200° C., 0.8 mbar |
| 7 | OBT | None | Jet-milled | No data | 7 h at 185° C., followed by 15 h at 210° C., 0.8 |
| 8 | OBT | None | Mechanical | 33800^{b} | mbar in 10 h from 170 to 188° C. + 30 h isothermal, |
| | | | Cryo-milled | | 2.6 mbar, 0.2 g N₂/h/kg |
| C9 | Used PBT | None | No data | No data | No annealing, depolymerization to Re-OBT |
| 10 | Re-OBT | None | Mechanical | No data | 1.5 h at 150° C., 1.5 h at 180° C., followed by 25 h |
| | | | Cryo-milled | | at 200° C., 0.8 mbar |
| 11 | PBT | None | ZM1 mill | No data | 1.5 h at 120° C., 2 h at 180° C., followed by 15.5 h |
| | copolymer 1 | | | | at 190° C., <0.5 mBar, no N₂ |
| 12 | PBT | None | ZM1 mill | No data | 3 h at 180° C. followed by 17 h at 190° C., <0.5 |
| | copolymer 2 | | | | mBar, no N₂ |
| C13 | PBT | None | ZM1 mill | No data | 1 h at 130° C., followed by 2.5 h ramped from |
| | copolymer 3 | | | | 150° C. -170° C., <0.5 mBar, No N₂ |
| 14 | PBT | None | IKA mill | No data | 2 h at 160° C., 2.3 h at 170° C., followed by 21.6 h |
| | copolymer 4 | | | | at 190° C., <0.5 mBar, no N₂ |
| 15 | OBT | 30% glass | ZM1 mill | No data | 3 h at 150° C., 16 h at 185° C., followed by 24 h at |
| | | beads | | | 195° C. and 17 h at 200° C. , <1 mBar, no N₂ |

TABLE 2

| | D50 | | | | | |
|---|---|---|---|---|---|---|
| | particle | | | | | Sinterability |
| Sample | size | Tₘ | T_{c} | Tₘ, onset | T_{c}, onset | Region |
| C1 | 94 | 225 | 195 | 205 | 201 | 4 |
| 2 | 95 | 220 | 193 | 215 | 200 | 15 |
| 3 | 95 | 225 | 193 | 221 | 201 | 20 |
| C4 | 44 | 218 | 196 | 193 | 201 | * |
| 5 | 44 | 222 | 190 | 214 | 198 | 16 |
| 6 | 45 | 229 | 186 | 221 | 195 | 26 |
| 7 | 50 | 241 | 190 | 234 | 197 | 37 |
| 8 | 58 | 230 | 186 | 222 | 194 | 28 |
| C9 | No data | 222 | 197 | 197 | 202 | * |
| 10 | No data | 233 | 183 | 227 | 191 | 36 |
| 11 | ** | 219 | 171 | 213 | 188 | 25 |
| 12 | ** | 220 | 170 | 211 | 186 | 25 |
| C13 | ** | 165 | 142 | 154 | 169 | * |
| 14 | ** | 220 | 146 | 204 | 169 | 35 |
| 15 | No data | 231 | 204 | 223 | 209 | 14 |

* Sample exhibited overlap between melting and crystallization curves, so sinterability window is theoretically a negative value.
** Samples were not further sieved; as such particle sizes ranged from 188 to 619 μm. It is not expected that the sieving would have any appreciable effect on the sinterability region of the powder itself.

### Example 16 a-d

For this experiment, the recyclability of powders according to the invention was investigated. First, a portion of PBT powder (Example 16a) was provided. Such PBT powder was made via the process described in example 10, having the same characteristics thereof described in Tables 1-2 above.

Next, the powder was subjected to a depolymerization step. For the first recycling iteration, 60 grams of powder (example 16a) and 1.8 g BD were added to a 200 ml glass reactor with mechanical stirrer and electrical heating. The reactor was then closed, and the air therein removed by applying a full vacuum to the reactor and using nitrogen to increase the pressure to atmospheric pressure (this process was conducted a total of 3 separate times). Then, the reaction mixture temperature was set to 260° C. and mixed at 200 rpm steadily until it became optically clear. When the reaction mixture was homogeneously molten (observed at approximately 1 hour), the reactor content was quenched in 1 liter of deionized water while stirring. The resulting oligomeric PBT was filtered and dried at 80° C. under a vacuum overnight.

Once the drying process had been completed, the dried oligomeric PBT material (now appearing as flakes) was then transferred to an IKA A11 basic mill, whereupon the flakes were subsequently ground down to a D50 particle size of approximately 200 microns.

Next, the ground material was subjected to a solid-state post condensation process, wherein the 50 g of milled powder was subjected to a temperature of 190 degrees Celsius and full vacuum for 48 hours. Finally, the sinterability region of the recycled PBT powder was measured via DSC methods elsewhere described herein. The results of the DSC measurements for this once-recycled PBT powder are depicted in Table 3 below under the heading 16b.

To ensure that the recycled PBT did not lose its ability to be useful in additive manufacturing processes even after multiple recycling iterations, the aforementioned steps were run two additional times on at least a portion of the same starting PBT powder. In creating the twice-recycled PBT powder, all of the steps with regard to the once-recycled PBT powder were repeated.

In creating the thrice-recycled PBT powder, meanwhile, a 7 g sample of the PBT powder was utilized instead of a 50 g sample with all other depolymerization, quenching, drying, and milling steps remaining identical. Further, the SSPC in the third recycling attempt was varied by taking 3 g of milled powder and heating it under SSPC to 190 degrees Celsius for only 20 hours. The results of the DSC measurements for the twice- and thrice-recycled PBT powder are depicted in Table 3 below under the headings 16c and 16d.

TABLE 3

| | D50 Particle | | | Tₘ, | T_{c}, | Sinterability |
|---|---|---|---|---|---|---|
| Sample | size | Tₘ | T_{c} | onset | onset | Region |
| 16a | 60 | 239 | 191 | 233 | 200 | 33 |
| 16b | No data | 229 | 189 | 224 | 199 | 25 |
| 16c | No data | 240 | 188 | 234 | 196 | 38 |
| 16d | No data | 229 | 191 | 222 | 197 | 25 |

As can be seen from Tables 1 and 2, powders according to the present invention possess larger sinterability regions, which facilitates their ready processability in additive manufacturing processes, such as selective laser sintering (SLS) and multi-jet fusion (MJF) methods. Demonstrated is the ability to increase the so-called sinterability region in pure PBT powders, PBT copolymer powders, as well as a compounded PBT powder (or compounded PBT copolymer powder).

Table 3 shows that the materials described herein, when subjected to the treatment also described herein, are easily recycled such that the beneficial properties imparted initially may be retained over multiple uses. This suggests that materials according to the present invention may be reused and recycled despite multiple uses in additive manufacturing processes.

### Additional Exemplary Embodiments

A first embodiment of a first additional exemplary aspect is a process for manufacturing a particulate composition comprising a polybutylene terephthalate (PBT) powder or a PBT copolymer powder for 3D printing comprising:
a. providing an oligomeric butylene terephthalate (OBT) or an OBT copolymer;
b. optionally, micronizing the OBT or OBT copolymer to form an OBT powder or OBT copolymer powder;
c. optionally, emulsion solidifying the OBT powder or OBT copolymer powder to form an emulsion-solidified OBT powder or emulsion-solidified OBT copolymer powder; and
d. subjecting the OBT powder, OBT copolymer powder, emulsion-solidified OBT powder, or emulsion-solidified OBT copolymer powder to solid-state post condensation to form a PBT powder or PBT copolymer powder possessing a D50 particle size in the range of 20 to 200 μm, or from 20 to 15 μm, or from 20 to 100 μm, or from 30 to 80 μm, or from 40 to 50 μm; wherein either the milling or emulsion solidifying steps, or both, are performed; and
   wherein the PBT powder or PBT copolymer powder possesses a sinterability region of at least 10° C., or at least 11° C., or at least 12° C., or at least 13° C., or at least 14° C., or at least 15° C., or at least 20° C., or at least 25° C., or between 14-40° C., or between 15-35° C., or between 20-35° C., or between 25-35° C., or between 15-25° C., or between 15-20° C., or between 30-40° C., or between 35-40° C.

Another embodiment of the first additional exemplary aspect is the process of the previous embodiment, wherein the OBT or OBT copolymer provided possesses a number average molecular mass of less than 9000 g/mol.

Another embodiment of the first additional exemplary aspect is the process of the previous embodiment, wherein the OBT or OBT copolymer is the reaction product of a terephthalic acid (TPA)-based compound and a hydroxyl-containing compound in the presence of a catalyst to form OBT or OBT copolymer having a number average molecular mass of less than 9000 g/mol.

Another embodiment of the first additional exemplary aspect is the process of any of the previous embodiments, wherein the micronizing step comprises milling.

Another embodiment of the first additional exemplary aspect is the process of any of the previous embodiments, wherein the TPA-based compound comprises TPA or dimethyl terephthalate.

Another embodiment of the first additional exemplary aspect is the process of any of the previous embodiments, wherein the hydroxyl-containing compound comprises 1,4-butanediol.

Another embodiment of the first additional exemplary aspect is the process of any of the previous embodiments, wherein the OBT or OBT copolymer has a number average molecular mass of 1000 g/mol to 5000 g/mol, or from 2000 g/mol to 4000 g/mol.

Another embodiment of the first additional exemplary aspect is the process of any of the previous embodiments, wherein the OBT or OBT copolymer comprises one or more endgroups, wherein at least 75%, or at least 80%, or at least 90%, or at least 95%, or at least 99% of the endgroups are hydroxyl groups, when tested via NMR.

Another embodiment of the first additional exemplary aspect is the process of any of the previous embodiments, wherein the PBT powder or PBT copolymer powder has a number average molecular mass (Mₙ) of 10 000 g/mol to 100 000 g/mol, or from 20 000 g/mol to 40 000 g/mol.

Another embodiment of the first additional exemplary aspect is the process of any of the previous embodiments, wherein the catalyst comprises titanium or magnesium acetate.

Another embodiment of the first additional exemplary aspect is the process of any of the previous embodiments, wherein the reaction which forms the OBT or OBT copolymer is carried out at a temperature of between 140 to 230° C.

Another embodiment of the first additional exemplary aspect is the process of any of the previous embodiments, further comprising introducing at least one additive, wherein the additive comprises flame retardants, flow aids, fillers, pigments, stabilizers, or glass fillers.

Another embodiment of the first additional exemplary aspect is the process of the previous embodiment, where the introducing step occurs between the providing step (a) and the milling step (b).

Another embodiment of the first additional exemplary aspect is the process of any of the two previous embodiments, wherein the introducing step occurs between the milling step (b) and the subjecting step (d).

Another embodiment of the first additional exemplary aspect is the process of any of the previous embodiments, wherein the micronizing step comprises milling, wherein the milling further comprises a jet milling or mechanical grinding process, wherein the jet milling or mechanical grinding process is carried out at a temperature of 15 to 35° C., or from 15 to 30° C.

Another embodiment of the first additional exemplary aspect is the process of any of the previous embodiments, wherein the emulsion solidifying step involves the emulsification of the OBT, OBT copolymer, OBT powder, or OBT copolymer powder in a silicone oil or ionic liquid solvent.

Another embodiment of the first additional exemplary aspect is the process of any of the previous embodiments, further comprising compounding the OBT powder or OBT copolymer powder with at least one or more additives, wherein the additives comprise flame retardants, flow aids, fillers, pigments, stabilizers, or glass fillers.

Another embodiment of the first additional exemplary aspect is the process of any of the previous embodiments, wherein the OBT copolymer is an OBT copolyester.

Another embodiment of the first additional exemplary aspect is the process of any of the previous embodiments, wherein the OBT copolymer and/or PBT copolymer possesses a Tₘ, onset value of at least 120, or at least 130, or at least 140, or at least 150, or at least 160, or at least 175, or at least 185, or at least 200° C., or between 120 and 250° C., or between 130 and 240° C., or between 150 and 230° C.

Another embodiment of the first additional exemplary aspect is the process of any of the previous embodiments, wherein the OBT copolymer and/or PBT copolymer comprises, consists essentially of, or consists of a copolymer having a block which is the reaction product of a dimer fatty acid, 1,4-butanediol, dimethyl terephthalate, or polytetrahydrofuran.

Another embodiment of the first additional exemplary aspect is the process of the previous embodiment, wherein the PBT copolymer further comprises a PBT hard block.

Another embodiment of the first additional exemplary aspect is the powder of any of the previous embodiments, wherein the PBT copolymer contains at least 5%, or at least 10%, or at least 20%, or at least 30%, or at least 40%, or at least 50% molar equivalents of glycols.

Another embodiment of the first additional exemplary aspect is the process of any of the previous embodiments, wherein the particulate composition comprises, consists essentially of, or consists of PBT powder.

A first embodiment of a second additional exemplary aspect of the invention is a polybutylene terephthalate (PBT) powder (or copolyesters thereof) for 3D printing having a number average molecular mass from 20 000 g/mol to 40 000 g/mol and a sinterability region of at least 10° C., or at least 11° C., or at least 12° C., or at least 13° C., or at least 14° C., or at least 15° C., or at least 20° C., or at least 25° C., or between 14-40° C., or between 15-35° C., or between 20-35° C., or between 25-35° C., or between 15-25° C., or between 15-20° C., or between 30-40° C., or between 35-40° C.

Another embodiment of the second additional exemplary aspect is the powder of the previous embodiment, wherein the PBT powder (or copolyester thereof) possesses a and a melting point onset temperature onset) of at least 210° C., or at least 220° C., or at least 225° C.

Another embodiment of the second additional exemplary aspect is the powder of any of the previous embodiments, wherein the PBT powder (or copolyester thereof) is a polymer compound powder.

Another embodiment of the second additional exemplary aspect is the powder of any of the previous embodiments, wherein the PBT powder (or copolyester thereof) is compounded with one or more additives, wherein the additives comprise flame retardants, flow aids, fillers, pigments, stabilizers, or glass fillers.

Another embodiment of the second additional exemplary aspect is the powder of any of the previous embodiments, wherein the PBT copolyester powder comprises a PBT hard block and a soft block comprising the reaction product of one or more of a dimer fatty acid, a butanediol, a dimethyl terephthalate, and/or a polytetrahydrofuran.

Another embodiment of the second additional exemplary aspect is the powder of any of the previous embodiments, wherein the PBT copolyester powder possesses a Tₘ, onset value of at least 120° C., or at least 150° C., or between 150 and 230° C.

Another embodiment of the second additional exemplary aspect is the powder of any of the previous embodiments, wherein the PBT copolyester contains at least 5%, or at least 10%, or at least 15%, or at least 20%, or at least 25%, or at least 35%, or at least 50% molar equivalents of glycols.

Another embodiment of the second additional exemplary aspect is the powder of any of the previous embodiments, wherein the powder consists essentially of, or consists of a pure PBT powder.

A first embodiment of a third additional exemplary aspect is a process for manufacturing a polyester powder for 3D printing comprising:
a. providing an oligoester;
b. either (i) micronizing, (ii) emulsion solidifying; or (iii) both micronizing and emulsion solidifying the oligoester to form an oligoester powder having a D50 particle size in a range of 20 to 200 μm, or from 30 to 80 μm; and
c. subjecting the oligoester powder to a solid-state post condensation to form a polyester powder;
   wherein the polyester powder possesses a sinterability region of at least 10° C., or at least 11° C., or at least 12° C., or at least 13° C., or at least 14° C., or at least 15° C., or at least 20° C., or at least 25° C., or between 14-40° C., or between 15-35° C., or between 20-35° C., or between 25-35° C., or between 15-25° C., or between 15-20° C., or between 30-40° C., or between 35-40° C.

Another embodiment of the third additional exemplary aspect is the process of the previous embodiment, wherein the oligoester is the reaction product of a terephthalic acid (TPA)-based compound or a naphthalene dicarboxylic acid-based compound and a hydroxyl-containing compound in the presence of a catalyst.

Another embodiment of the third additional exemplary aspect is the process of either of the previous embodiments, wherein the oligoester possesses a number average molecular mass of less than 9000 g/mol.

Another embodiment of the third additional exemplary aspect is the process of any of the previous embodiments, wherein the polyester powder has a number average molecular mass from 10 000 g/mol to 100 000 g/mol, or from 20 000 g/mol to 40 000 g/mol.

Another embodiment of the third additional exemplary aspect is the process of either of the two previous embodiments, wherein the TPA-based compound comprises TPA, or the naphthalene dicarboxylic acid comprises naphthalene dicarboxylic acid.

Another embodiment of the third additional exemplary aspect is the process of any of the previous embodiments, wherein the hydroxyl-containing compound comprises ethylene glycol, 1,4-butanediol, or 1,3-propanediol.

Another embodiment of the third additional exemplary aspect is the process of any of the previous embodiments, wherein the polyester powder comprises polyethylene terephthalate (PET), polybutylene terephthalate (PST), polytrimethylene terephthalate (PTT), or polyethylene naphthalate (PEN).

Another embodiment of the third additional exemplary aspect is the process of any of the previous embodiments, wherein the polyester powder possesses a D50 particle size in the range of 40 to 50 μm, a number average molecular mass from 20 000 g/mol to 40 000 g/mol, and a melting point onset temperature (Tₘ, onset) of at least 210° C., or at least 220° C., or at least 225° C.

Another embodiment of the third additional exemplary aspect is the process of any of the previous embodiments, wherein the polyester powder is compounded with one or more additives, wherein the additives comprise flame retardants, flow aids, fillers, pigments, stabilizers, or glass fillers.

Another embodiment of the third additional exemplary aspect is the process of any of the previous embodiments, wherein the polyester powder is a polymer compound powder.

Another embodiment of the third additional exemplary aspect is the process of the previous embodiment, further comprising at least one additive, wherein the additive comprises flame retardants, flow aids, fillers, pigments, stabilizers, or glass fillers.

Another embodiment of the third additional exemplary aspect is a 3D printed article prepared from the polyester compound powder as described in any of the previous embodiments.

Another embodiment of the third additional exemplary aspect is the process of any of the previous embodiments, wherein the polyester powder comprises, consists essentially of, or consists of a PBT powder or a PBT copolymer powder.

Another embodiment of the third additional exemplary aspect is the powder of any of the previous embodiments, wherein the PBT copolymer powder comprises a PBT hard block and a soft block comprising the reaction product of one or more of a dimer fatty acid, a butanediol, a dimethyl terephthalate, and/or a polytetrahydrofuran.

Another embodiment of the third additional exemplary aspect is the powder of any of the previous embodiments, wherein the PBT copolymer powder possesses a Tₘ, onset value of at least 120° C., or at least 150° C., or between 150 and 230° C.

Another embodiment of the third additional exemplary aspect is the powder of any of the previous embodiments, wherein the PBT copolymer contains at least 5%, or at least 10% molar equivalents of glycols.

Another embodiment of the third additional exemplary aspect is the powder of any of the previous aspects, wherein the polyester powder comprises, consists essentially of, or consists of a PBT powder.

A first embodiment of a fourth additional exemplary aspect is a method of forming an object via an additive manufacturing process comprising the steps of:
providing a layer of a particulate composition, the particulate composition comprising a polyester powder having a melting point onset temperature (Tₘ, onset), a crystallization onset temperature (T_{c}, onset), and a sinterability region (Tₘ, onset−T_{c}, onset), wherein the sinterability region of the polyester powder is greater than 10, or greater than 14, or greater than 15, or greater than 20, or greater than 25, or greater than 30° C.;
applying electromagnetic radiation to at least one location on the layer of the particulate composition, wherein the particulate composition undergoes melting in at least some of the locations where the electromagnetic radiation has been applied to form a fused section in accordance with computer data corresponding to a portion of a three-dimensional object to be formed; and
repeating the previous steps a plurality of times to form a fused three-dimensional object.

An additional embodiment of the fourth additional exemplary aspect is a method according to the previous embodiment, further comprising the step of, prior to the applying step, selectively depositing a liquid composition onto the layer of the particulate composition, wherein at least one of the particulate composition or liquid composition comprises a fusing agent.

An additional embodiment of the fourth additional exemplary aspect is the method according to the previous embodiment, wherein the applying step alternatively occurs at a specified location upon the liquid composition which has been selectively deposited onto the particulate composition, and wherein the particulate composition undergoes melting in at least some of the locations where the liquid composition has been applied to form the fused section.

An additional embodiment of the fourth additional exemplary aspect is the method of any of the previous embodiments, wherein the polyester powder is defined by any of the powders formed by any of the embodiments of the first or third additional exemplary aspects, or the powder of any of the embodiments of the second additional exemplary aspect.

An additional embodiment of the fourth additional exemplary aspect is the method according to the previous embodiments, wherein the fusing agent further comprises an energy absorber, a thermal initiator, or a photoinitiator.

A first embodiment of a fifth additional exemplary aspect is a process of recycling a polyester powder obtained from 3D printing comprising:
providing a quantity of polyester powder;
depolymerizing the polyester to form an oligomeric polyester with a number average molecular mass from 500 g/mol to 6000 g/mol;
optionally, removing additives or monomer fragments;
optionally, introducing new additives;
optionally, milling the oligomeric polyester to form a powder having a D50 particle size in the range of 20 to 650 μm, or from 20 to 200 μm, or from 40 to 50 μm;
optionally, sieving the powder to form a powder having a D50 particle size in the range of from 30 to 80 μm, or from 40 to 50 μm;
optionally, emulsion solidifying the oligomeric polyester or oligomeric polyester powder; and
subjecting the recycled oligomeric polyester powder to solid-state post condensation to form a polyester powder, wherein up to 100%, or from 1 to 80%, or from 20 to 100%, or from 20 to 80%, or from 30 to 100%, or from 30 to 80%, or from 25 to 75% of the polyester powder is recycled.

An additional embodiment of the fifth additional exemplary embodiment is the process of the previous embodiment, wherein the polyester powder is polybutylene terephthalate (PBT) or copolymer thereof, the oligomeric polyester is oligo-butylene terephthalate (OBT) or copolymer thereof, and the oligomeric polyester powder is OBT powder or a copolymer thereof.

An additional embodiment of the fifth additional exemplary embodiment is the process of either of the previous two embodiments, wherein the oligomeric polyester is oligo-butyleneterephthalate (OBT).

An additional embodiment of the fifth additional exemplary embodiment is the process of any of the previous embodiments, wherein, prior to milling, removing at least one of particulate additives and degraded monomer fragments.

An additional embodiment of the fifth additional exemplary embodiment is the process of the previous embodiment, wherein the removing step involves filtration.

An additional embodiment of the fifth additional exemplary embodiment is the process of any of the previous embodiments, wherein prior to or after milling, introducing new particulates or additives.

An additional embodiment of the fifth additional exemplary embodiment is the recycled polymer powder formed from the process of any of the previous embodiments, wherein the recycled polymer powder comprises PBT powder.

An additional embodiment of the fifth additional exemplary embodiment is the process of the previous embodiment, wherein the recycled polymer powder possesses a D50 particle size in a range of 40 to 50 μm and a number average molecular mass (Mₙ) of 10 000 g/mol to 100 000 g/mol, or from 20 000 g/mol to 40 000 g/mol.

An additional embodiment of the fifth additional exemplary embodiment is the process of the previous embodiment, further possessing a melting point onset temperature (Tₘ, onset) and a crystallization point onset temperature (T_{c}, onset), wherein the Tₘ, onset minus T_{c}, onset is a sinterability region, wherein the sinterability region of the PBT is at least 10° C., or at least 11° C., or at least 12° C., or at least 13° C., or at least 14° C., or at least 15° C., or at least 20° C., or at least 25° C., or between 14-40° C., or between 15-35° C., or between 20-35° C., or between 25-35° C., or between 15-25° C., or between 15-20° C., or between 30-40° C., or between 35-40° C.

A first embodiment of a sixth additional exemplary aspect of the invention is a method of forming a three-dimensional object comprising the steps of:
a. providing a layer of a particulate composition, the particulate composition comprising a plurality of recycled polymer particles;
b. selectively applying electromagnetic radiation onto the layer of the particulate composition in accordance with computer data corresponding to the shape of at least a portion of a three-dimensional object, wherein the particulate composition undergoes melting in at least some of the locations where the electromagnetic radiation has been applied; and
c. repeating steps a-b a plurality of times to form a sintered three-dimensional object.

An additional embodiment of the sixth additional exemplary aspect is the method of the previous embodiment, wherein the particulate composition comprises a recycled polymer particle in accordance with any of those described according to any of the embodiments of the fifth additional exemplary embodiment.

An additional embodiment of the sixth additional exemplary aspect is the method of the previous embodiment, wherein the particulate composition comprises a recycled polymer particle formed according to any of the embodiments of the fifth additional exemplary embodiment.

An additional embodiment of the sixth additional exemplary aspect is the method of any of the previous embodiments, wherein the recycled polymer particles are suitable for 3D printing and have a D50 particle size in a range of 40 to 50 μm, a number average molecular mass (Mₙ) of 10 000 g/mol to 100 000 g/mol, or from 20 000 g/mol to 40 000 g/mol.

An additional embodiment of the sixth additional exemplary aspect is the method of any of the previous embodiments, wherein the sinterability region of the recycled polymer particles is at least 10° C., or at least 11° C., or at least 12° C., or at least 13° C., or at least 14° C., or at least 15° C., or at least 20° C., or at least 25° C., or between 14-40° C., or between 15-35° C., or between 20-35° C., or between 25-35° C., or between 15-25° C., or between 15-20° C., or between 30-40° C., or between 35-40° C. An additional embodiment of the sixth additional exemplary aspect is the method of any of the previous embodiments, wherein the recycled polymer particles possess a Tₘ, onset of at least 210° C., or at least 220° C., or at least 225° C., or from 220° C. to 250° C., or from 225° C. to 240° C., or from 220° C. to 230° C., or from 225° C. to 240° C., or from 225° C. to 230° C.

A first embodiment of a seventh additional exemplary aspect is a method of forming a three-dimensional object comprising the steps of:
a. forming a layer of a particulate composition, the particulate composition comprising a plurality of recycled polymer particles and a resin component;
b. selectively depositing a liquid composition onto the layer of the particulate composition in accordance with computer data corresponding to the shape of at least a portion of a three-dimensional object, wherein at least one of the particulate composition or the resin component comprises a fusing agent, the fusing agent further comprising an energy absorber, a thermal initiator, or a photoinitiator;
c. applying electromagnetic radiation to at least the locations of the layer of the particulate composition where the liquid composition has been selectively deposited, wherein the particulate composition undergoes melting in the locations where the liquid composition has been selectively deposited and while undergoing melting, or while molten the fusing agent initiates polymerization of at least the first resin; and
d. repeating steps a-c a plurality of times to form a three-dimensional object.

Another embodiment of the seventh additional exemplary aspect is the method of the previous embodiment, wherein the particulate composition comprises a recycled polymer particle according to any of the embodiments of the fifth additional aspect of the invention.

Another embodiment of the seventh additional exemplary aspect is the method of either of the previous embodiments, wherein the particulate composition comprises a recycled polymer particle formed according to any of the methods of any of the embodiments of the fifth additional aspect of the invention.

An eighth additional aspect of the invention is a kit of materials for additive manufacturing comprising:

at least one of:
(i) a polybutylene terephthalate (PBT) powder or a PBT copolyester powder formed by the method of any of the embodiments of the first exemplary aspect;
(ii) the polybutylene terephthalate (PBT) powder or PBT copolyester powder of any of embodiments of the second additional exemplary aspect; or
(iii) the polyester powder formed by the method of any of the embodiments of the third additional exemplary aspect;
and a fusing agent, wherein the fusing agent further comprises an energy absorber, a thermal initiator, or a photoinitiator.

An additional embodiment of the eight additional aspect of the invention is the kit of materials for additive manufacturing of the previous embodiment, wherein the kit comprises, consists essentially of, or consists of PBT powder.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A method of forming an object via an additive manufacturing process comprising the steps of:
a. providing a layer of a particulate composition, the particulate composition comprising a polyester powder having a melting point onset temperature (Tₘ, onset), a crystallization onset temperature (T_{c}, onset), and a sinterability region (Tₘ, onset−T_{c}, onset), wherein the sinterability region of the polyester powder is greater than 14° C., when determined in accordance with ISO 11357-1 (2009);
b. optionally, selectively depositing a liquid composition onto the layer of the particulate composition, wherein at least one of the particulate composition or liquid composition comprises a fusing agent;
c. applying electromagnetic radiation to at least one of:
(i) a specified location on the layer of the particulate composition, or
(ii) a location at which the liquid composition which has been selectively deposited onto the particulate composition;
wherein the particulate composition undergoes melting in at least some of the locations where the electromagnetic radiation and/or the liquid composition has been applied to form a fused section in accordance with computer data corresponding to a portion of a three-dimensional object to be formed; and
d. repeating steps (a), optionally (b), and (c) a plurality of times to form a fused three-dimensional object.

2. The method of claim 1, wherein the polyester powder comprises polybutylene terephthalate (PBT) or a copolymer thereof.

3. The method according to claim 2, wherein the polyester powder possesses a number average molecular weight from 20,000 g/mol to 50,000 g/mol, as determined by H-NMR, and wherein the sinterability region of the polyester powder is between 14-40° C.

4. The method according to claim 2, wherein the particulate composition further comprises one or more additives, wherein the additives comprise flame retardants, flow aids, fillers, pigments, or stabilizers.

5. The method according to claim 2, wherein the polyester powder is a polymer compound powder, wherein one or more flame retardants or glass beads are compounded into the polyester powder.

6. The method according to claim 2, wherein polyester powder possesses a D50 particle size of 30 to 80 μm wherein D50 is determined in accordance with ISO 13320-1.

7. The method according to claim 2, wherein the polyester powder is formed by a process comprising the steps of:
providing an oligoester having a number average molecular mass from 1000 g/mol to 5000 g/mol;
optionally, micronizing the oligoester to form an oligoester powder;
optionally, emulsion solidifying the oligoester or oligoester powder to form an emulsion-solidified oligoester powder; and
subjecting the oligoester powder or emulsion-solidified oligoester powder to a solid-state post condensation (SSPC) process;
wherein either the micronizing or emulsion solidifying steps, or both, are performed.

8. The method according to claim 7, wherein the oligoester is formed by combining a terephthalic acid (TPA)-based compound and a hydroxyl-containing compound at a temperature of between 140 to 230° C. in the presence of a catalyst.

9. The method according to claim 7, wherein the micronizing step comprises milling, wherein the milling further comprises a cryogenic milling, jet milling, or mechanical grinding process.

10. The method according to claim 9, wherein the milling step comprises a jet milling or mechanical grinding process, wherein the jet milling or mechanical grinding process is carried out at a temperature of 15 to 35° C.

11. The method according to claim 7, wherein the emulsion solidifying step involves the emulsification of the oligoester or oligoester powder in a silicone oil or ionic liquid solvent.

12. The method according to claim 7, wherein the SSPC step further comprises one or more of the following:
(i) heating the oligoester powder or emulsion-solidified oligoester powder at a temperature of greater than 165° C. for at least 5 hours;
(ii) optionally, applying a vacuum at a pressure from 0.01 millibar (mbar) to 10 mbar during the heating; and
(iii) optionally, applying an inert gas during the heating;
wherein the heating step involves heating the oligoester powder or emulsion-solidified powder to a temperature up to either
A. at most 10° C. less than the melting point of the oligoester powder or emulsion-solidified oligoester powder, or
B. less than the Tₘ, onset of the oligoester powder or emulsion-solidified oligoester powder;
wherein melting point and Tₘ, onset are determined in accordance with ISO 11357-3 (2009).

13. The method according to claim 8, wherein TPA-based compound consists essentially of TPA or dimethyl terephthalate, and wherein the hydroxyl-containing compound consists essentially of 1,4-butanediol, and wherein the oligoester consists essentially of oligo-butylene terephthalate (OBT).

14. The method according to claim 2, wherein the polyester powder consists essentially of PBT or a copolymer thereof, and wherein the PBT or copolymer thereof possesses a sinterability region of between 15-40° C.

15. The method according to claim 14, wherein the polyester powder comprises a copolymer having a PBT hard block; and
wherein the polyester powder possesses a sinterability region of between 20-35° C.

16. The method according to claim 15, wherein the polyester powder consists of a copolymer having a block which is the reaction product of a dimer fatty acid, butanediol, dimethyl terephthalate, or polytetrahydrofuran.

17. The method according to claim 16, wherein the Tₘ, onset of the copolymer is at least 120° C.

18. The method according to claim 16, wherein the Tₘ, onset of the polyester powder is from 220° C. to 250° C.

19. The method according to claim 2, wherein step (b) is carried out, further wherein the fusing agent facilitates melting of the particulate composition and further comprises an energy absorber, a thermal initiator, or a photoinitiator.

20. The method according to claim 2, wherein the polyester powder comprises recycled powder.
